(19) United States
(12) Patent Application Publication
(10) Pub. No.: US 2024/0247967 A1
(43) Pub. Date: Jul. 25, 2024

(54) Water Meter and Leak Detection System

(71) Applicant: Michael Edward Klicpera, Incline Village, NV (US)

(72) Inventor: Michael Edward Klicpera, Incline Village, NV (US)

(21) Appl. No.: 17/981,454

(22) Filed: Nov. 6, 2022

(51) Int. Cl. G01F 25/10; H04W 4/38

(52) U.S. Cl. CPC G01F 25/10; H04W 4/38

(57) ABSTRACT

The present invention is a system comprised of a water meter collection node system with water valve control mechanism or shut-off/on mechanism with wireless technology to communication with a private or corporate network, or internet connection that transfer water parameter data to a remote computer or server. Or the system can consist of a water meter collection node (water meter) that communicates with a communication hub that function to extend the range of wireless transmissions whereby the communication hub that is in wired or includes wireless communication with an internet router that communicates with an internet connection, or the collect node or communication hub can wirelessly communicate with a private or commercial network system, to a remote computer/server or a cloud service commercial service. One or more communication hub can function as a repeater apparatus to also extent the range of wireless transmissions.

### FIELD OF THE INVENTION

This apparatus and the method of use relates to water supply systems. More particularly, the invention relates to a water meter and leak detection system for private and/or public property to monitor and provide water use and water leak information and to minimize water loss and related damage.

### BACKGROUND OF THE INVENTION

Water is increasingly becoming a precious resource. While fresh water supplies have been challenged due to climate (short rainy seasons and long droughts) and increased pollution, water demand has been rising due to the growing population along with increased development. The increasingly limited supply of fresh water is a humanitarian concern and water conservation is becoming a major issue for many communities. An apparatus for real-time monitoring of water use, and real-time detection of leak conditions at private and/or public property (e.g., residential structures and yards, business/industrial/commercial facilities, and governmental/institutional sites) can be useful in assessing and controlling water resources and supporting water conservation.

Water losses to private and/or public properties caused by broken or compromised water pipes and by unobserved leaks are enormous. Broken or compromised water pipes are often undetected, for example when the property owner is absent or sleeping, and the resulting water loss and property damage can be catastrophic, Property insurance agencies report that a significant portion of total insurance losses are water related. It has been found that losses due to water leaks in residential homes can amount to a significant percentage of the total water use.

### SUMMARY OF THE INVENTION

The water meter and leak detection system monitor real-time water use and provides real-time leak detection and notification for private and/or public property (e.g., residential structures and yards, business/industrial/commercial facilities, and/or governmental/institutional sites). The present invention connects in series to the water supply for one or more private and/or public properties. This invention comprises a water meter collection node and an optional communication hub 477. The collection node is essentially a water meter which can include: one or more water flow rate sensors, one or more optional control valves, one or more optional temperature sensors, one or more optional pressures sensors, one or more optional acoustic sensors, and wireless radio technology. Use of the optional communication hub 477 extends the wireless range capability. The communication hub 477 can also serve as a repeater apparatus or access point for receiving water data and transmitting water data to also provide longer wireless range capability. In this capability the communication hub 477 that can function as a repeater or an access point might have a limited or different electronic components that are directed to function as the repeater apparatus. The water meter collection node 10 (126 shown in FIGS. 6 and 200 shown in FIG. 7) and optional communication hub 477 can utilize long range wireless technology [LoRa, Sigfox, WiMAX, Ultra Narrow Band (UNB), NB-IoT, M-Bus, 6LOWPAN, standard Wi-Fi and Wi-Fi versions 3/4/5/6 (with Wi-Fi extenders) and Amazon Sidewalk technology], limited range technology [Bluetooth, Bluetooth low energy (BLE), Zigbee and Z-wave], other wireless technology, wired and wired technology [X10, universal powerline bus (UPB), HART Communications Protocol], established cellular technology [3GPP, LTE-M, 4G and 5G], and any combinations thereof.

In one embodiment, the water meter collection node utilizes a Wi-Fi version 3/4/5/6, WiFi7, Li-Fi., LoRa, Sigfox, Ultra Narrow Band, 6LowPAN, NB-IoT, M-Bus, WIMAX, Amazon Sidewalk, standard cellular technology, LTE-M cellular technology, 3GPP, 4G and 5G cellular technology radio that communications with a private or corporate network. In another embodiment, the collection node utilizes a Wi-Fi version 3/4/5/6, WiFi7, Li-Fi, LoRa, Sigfox, Ultra Narrow Band, 6LowPAN, NB-IoT, M-Bus, WIMAX, Amazon Sidewalk, standard cellular technology, LTE-M cellular technology, 3GPP, 4G and 5G cellular technology radio that communications with the optional communication hub 477 that has a corresponding Wi-Fi version 3/4/5/6, WiFi7, Li-Fi, LoRa, Sigfox, Ultra Narrow Band, 6LowPAN, NB-IoT, M-Bus, WIMAX, Amazon Sidewalk, standard cellular technology, LTE-M cellular technology, 3GPP, 4G and 5G cellular technology that communications with the collection node and the communication hub has also Wi-Fi or Wi-Fi versions 3/4/5/6, Wi-Fi7 and Li-Fi second radio that communicates with a wireless router. The communication hub 477 can also serve as a repeater apparatus receiving water data and transmitting water data to also provide longer wireless range capability. Bluetooth, Bluetooth low energy (BLE), Zigbee, or Z-Wave can also be used for shorter range communications. The wireless communication technology can utilize and communicate with an application programming interface (API) protocol, a simple object access protocol (SOAP), a representational state transfer (REST) protocol, or another API technology. The API interface generally resides within a remote server and is software code that allows two programs to efficiently communicate with each other for website presentation and cell/smart phones. The wireless technology is in a half or full duplex format as water use monitoring transmits to a remote server while the leak detection capability needs to send a signal to control the water control valve. The long range wireless technologies Wi-Fi version 3/4/5/6, (with Wi-Fi extenders) WiFi7, Li-Fi, LoRa, Sigfox, Ultra Narrow Band, 6LowPAN, NB-IoT, M-Bus, WIMAX, Amazon Sidewalk, standard cellular technology, LTE-M cellular technology, 3GPP, 4G and 5G cellular technology, limited range technologies e.g. standard Wi-Fi, Bluetooth, Bluetooth Low Energy (BLE), Zigbee and Z-wave, wired technology e.g. X10, UPB, HART Communications Protocol, and established cellular technologies e.g. 3GPP, 4G, LTE-M, and 5G and any combinations thereof transfers data through a private or corporate network system or through a router connected to the internet. These methods of transfer communicate water use, water leaks, and/or water quality data to remote server(s) with database(es). The water meter and leak detection system is connected to the water supply piping using a continuous or water flow event basis, or on a demand basis for monitoring water use from the main water supply line used within private and/or public property. The present invention can be used with private and/or public water sources such as private wells and other non-municipal related water sources. The remote server and database can be used to support a computer portal that registered users or owners of designated cell or smart phones, computers, or similar apparatuses can use to access and observe water use, leak conditions, and/or water quality parameters for relevant private and/or public property.

The housing of the water meter and leak detection system collection node and optional communication hub 477 can be fabricated from materials and can use technologies that provide moist and wet conditions, hot environments, and cold/freezing protection properties. The water meter and leak detection system include a central processing unit (CPU), microprocessor and/or microcontroller, data storage memory, timing and wireless circuitry, water flow rate sensors, optional water quality sensors, optional pressure sensors, optional acoustic sensors, and an optional power generation technology. The types of water flow rate sensor(s) can be invasive type (i.e., located within water pipe and exposed to the water source; e.g., turbine sensor), non-invasive (i.e., located outside water pipe and isolated from the water source; e.g. ultrasonic sensor), and/or sensitive water flow sensors (e.g. pressure sensor). The water meter and leak detection system have the capability to utilize several different sensors to accomplish the goals of real-time monitoring water use and detecting leaks. Furthermore, the water meter and leak detection system can monitor separately indoor and outdoor water use or can monitor one or more designated areas of one or more sites. Optionally, a temperature sensor can be incorporated into the water meter collection node to determine, communicate, and address temperature conditions, e.g., assess freezing conditions (water temperature is approaching 32 degrees if Fahrenheit or 0 degrees Celsius) and communicate with the property structure's thermostat or heating system to maintain a specified temperature within the structure, drain water from pipes, and/or perform other damage protection methods. The optional pressure sensor, with associated use of the control valve, can be used for detecting extremely small leaks. This is accomplished by shutting off the water supply with the control valve and monitor pressure over period. The resulting loss of pressure can generate graphical curves or charts that demonstrate that type of small leak, e.g., leaking faucet, leaking toilet flapper valve.

The water meter and leak detection system with control valve(s) can be shut-off/on manually or by a programmed or set command or schedule using a cell or smart phone, computer, or other electronic apparatus. The water meter and leak detection system can be programmed to follow a work, vacation, or other custom schedule. The water meter and leak detection system can be set to automatically shut off when the property is un-occupied or vacant. The occupancy of the property can be determined by feedback from electronic lock(s), passive infrared sensor(s) (PIRs), alarm(s), security system(s), or other security devices. Furthermore, the water meter and leak detection system is designed with electrical and communication circuitry to send a signal to the cell or smart phone, computer, or other electronic apparatus that the water supply line is on or off.

The water meter and leak detection system provide wireless remote leak detection notification using water event or water event basis monitoring and software analysis. Alternately, continuous data monitoring can be stored in a data module in the water meter collection node and periodically transferred wirelessly to a remote computer or server as described herein. The water meter and leak detection system monitors water use and detects non-typical, abnormal, or continuous water use and alerts, signals, or messages via a cell or smart phone, computer, or similar apparatus to one or more property owners, users, or responsible individuals of any water leak condition(s). Thus, leak notification can be provided when the property is vacated or unsupervised.

The water meter and leak detection system's collection node communicate with a private or commercial network system or communicates with the optional communication hub 477 through a router to the internet.

The water meter and leak detection system's collection node with shut-off/on mechanism can be battery operated and can utilize re-chargeable batteries or super capacitators. The re-chargeable components can be connected to electricity generation means such as a water turbine generator(s), solar cell(s), or wind generation means to supplement electrical energy. The Water meter and leak detection system with shut-off/on mechanism can also be AC or DC powered.

Finally, many other features, objects and advantages of the present invention will be apparent to those of ordinary skill in the relevant arts, especially considering the following discussions, drawings, detailed descriptions, and claims.

### BRIEF DESCRIPTION OF THE DRAWINGS

FIG. 1 is an illustration of the embodiment comprising a water meter and leak detection system connected in series to the water supply piping to monitor water use and detect leak(s) for example property, a residential structure. FIG. 1 also shows several methods of wireless capability for the water meter and leak detection system to communicate water use and leak detection information to a conveniently located cell or smart phone, computer, or similar apparatus. FIG. 1 shows wireless communication for the property owner and/or municipal representative using a custom display/recorder for a governmental, civil, commercial, or municipal operators or agencies. In one example, FIG. 1 shows a wireless means for communicating directly to a homeowner, or offsite central monitoring computer using long range wireless technology and/or telephone lines via satellite, microwave technology, the internet, cell tower, telephone lines, and other similar technology.

FIG. 2 is a front illustration of an optional display on the apparatus base showing one or more inputs and outputs of a water supplies lines with a display means having one or more display screens and a plurality of hardware and/or software buttons.

FIG. 3 is an electrical schematic showing the main power, CPU or microcontroller, the analog or digital optional display means, the clock circuit, one or more flow sensors, optional temperature sensor, optional pressure sensor and/or water quality sensor(s), and optional water energy generator, and a first, second and/or third wireless communication technology for data transfer through either a private or public network system and/or the optional collection hub to an internet router. Similar electronic circuitry, without sensor technology, can be used with the optional communication hub. The communication hub can also serve as a repeater apparatus receiving water data and transmitting water data to also provide longer wireless range capability.

FIG. 4 is a cross-section illustration showing a plurality of water flow and water quality parameter sensors located in relative positions within the water supply line lumen and the connecting wires.

FIG. 5 is an illustration of an optional custom wireless display/recording remote apparatus having a plurality of display means and a plurality of software controlling buttons.

FIG. 6 is an illustration of a plurality of water parameter transceivers attached to various locations for monitoring water use.

FIG. 7 is an illustration of the water meter and leak detection system attached to a residential building with wind and solar energy generation and a person having a cell or smart phone, computer, or similar apparatus communicating with the Water meter and leak detection system for obtaining water parameter data or controlling a water control valve.

FIG. 8 is a more detailed illustration of the water meter collection node with the control circuit, a wireless transceiver, power supply, a water shut-off/on mechanism with a manual control, and water supply plumbing with optional water turbine energy generator that connected in series to the water supply line.

FIG. 9 is another embodiment of the present invention with a detailed illustration view of the water shut-off/on mechanism combined with an independent pressure reduction valve and functioning as a combined system consisting of a water meter collection node with one or more water flow sensors having a water shut-off/on mechanism and pressure reduction valve.

FIG. 10 is an illustration of an “APP” or programmed application that provides water use data in various example formats that is transferred from the water meter collection node to a database allowing access for a remote display/recording apparatus, web portal or a cell or smart phone, computer, or similar apparatus.

FIG. 11 is an illustration of another “APP” or programmed application, or another page of an “APP” or programmed application the displays water use data in another format that is transferred from the water meter collection node to a remote database for display on web portal, or a cell or smart phone, computer, or similar apparatus.

FIG. 12 is an enlarged illustration of another typical cell or smart phone, remote computer, web portal or similar electronic apparatus having an “APP” or programmed application, or another page of an “APP” or programmed application to display the soft buttons or control activator to turn on/or the water system, schedule the water control mechanism, or receive a test message.

FIG. 13 is an illustration of a typical cell or smart phone, remote computer, web portal, or similar electronic apparatus having another “APP” or programmed application, or another page of an “APP” or programmed application to display the soft buttons to determine the period for displaying, graphical of water use devices, leak detection graphical item, and programming and settings features.

FIG. 14 is a block diagram of the more integrated system showing the software, hardware, and applications of the home or corporate premises communicating with the water meter and leak detection system and communicating with the internet and remote computer services (“the Cloud”).

FIG. 15a is an illustration of the pressure drop within a typical 3-bedroom residence having copper plumbing and a pressure regulator wherein there is no leak.

FIG. 15b is an illustration of the pressure drop within a typical 3-bedroom residence having copper plumbing and a pressure regulator wherein the leak is approximately 20 ml/min.

FIG. 15c is an illustration of the pressure drop within a typical 3-bedroom residence having copper plumbing and a pressure regulator wherein the leak is approximately 60 ml/min.

The figures are not intended to be exhaustive or to limit the disclosed technology to the precise form disclosed. It should be understood that the disclosed technology can be practiced with modification and alteration, and that the disclosed technology be limited only by the claims and the equivalents thereof.

### DESCRIPTION OF THE PREFERRED EMBODIMENTS

The following description is non-limiting and is made merely for the purpose of describing the general principles of the disclosed embodiments. Numerous specific details are set forth to provide a full understanding of various aspects of the subject disclosure. It will be apparent, however, to one ordinarily skilled in the art that various aspects of the subject disclosure may be practiced without some of these specific details. In other instances, well-known structures and techniques have not been shown in detail to avoid unnecessarily obscuring the subject disclosure.

Water Use refers to the total volume or volume of water used over a period or duration of time. Water use requires the water flow rate and any changes during the monitoring period and the duration to calculate the actual volume of water used.

Water flow event or water flow event basis is defined as monitoring and sensing the initiation of water flow until the water flow is stopped, whereby the water flow rate, the duration of water flow, and the total water volume can be monitored (at a frequency of every 1-20 seconds) then calculated and recorded. The water flow event will inherently save CPU, microprocessor, and wireless transmission energy by not recording or transmitting no water use periods and allowing the CPU or microprocessor and wireless communication technology to go into a sleep mode between each water flow event and providing a superior analysis of water signatures and patterns for reliable discernment of leak and leak locations.

Water Energy Use refers to the ratio of cold or ambient water to heated water use or to the ratio of hot water to total water use.

Private and/or public property refers to the structure(s), site(s), area(s), land(s), and/or location(s) whether indoor, outdoor, or a combination thereof that is/are owned, controlled, used by or designated for use by any type of entity (i.e. personal, residential, commercial, corporate, business, industrial, establishment, government, administrative, institutional, organizational, etc.). Examples include but are not limited to homes and yards, office buildings, commercial structures and grounds, farming lands, government or institutional facilities, multi-unit apartments, condominiums or townhomes, hospitals, dormitories, university or corporate campuses, water or irrigation system defined areas, water wells, sports fields, exercise facilities, parks, golf courses, homeowner association (HOA) areas, and military bases.

Authentication refers to the technology that confirms or ensures that a message(s), control/command signal(s), data, and/or information that is downloaded and/or transferred from one person or device to another that is received only by the intended person or device. One example of a authentication method is the Challenge Handshake Authentication Protocol (CHAP) which provided authentication technology to a user communication with a network entity, which may be any remote private or corporate server and/or the internet using a service provider (e.g. ATT U-verse, Xfinity/Comcast). CHAP provides users authenticated passwords when accessing remote servers, which also are authenticated prior to allowing the user access. For example, short distance wireless technology Bluetooth, Bluetooth low energy (BLE), Zigbee, Z-wave and Wi-Fi, Wi-Fi versions 3/4/5/6 short range wireless technologies can be used for an authentication pairing procedure to initially establish remote wireless communications. Such authentication pairing procedure can be inputting a Service Set Identifier (SSID) and password which can include two-factor or three-factor authentication.

Encryption refers to a privacy technology that prevents anyone but the intended recipient(s) to access, download, read, or review a message(s), control/command signal(s), data, and/or information that provides a confidential transfer.

Integrity refers to technology that ensures that a message(s), control/command signal(s), data, and/or information is not altered, compromised, or corrupted during transmission or when accessed or downloaded.

Non-repudiation refers to the technology that confirms or ensure and prevents a sender or receiver from denying that a message(s), control/command signal(s), data, and/or information was sent or received.

Cellular format technology refers to all current and future variants, revisions and generations [e.g. third generation (3G), fourth generation (4G) and 3GPP (and enhancement revisions), fifth generation (5G), 3GPP cellular technology (Release 17 and 18), all future generations of Global System for Mobile Communication (GSM), General Packet Radio Service (GPSR), Code Division Multiple Access (CDMA), Evolution-Data Optimized (EV-DO), Enhanced Data Rates for GSM Evolution (EDGE), 3GSM, Digital Enhanced Cordless Telecommunications (DECT), Digital AMPS (IS-136/TDMA, Integrated Digital Enhance Network (iDEN), HSPA+, WiMAX, LTE, Flash-OFDM, HIPERMAN, Wi-Fi, IBurst, UMTS, W-CDMA, HSPDA+HSUPA, UMTS-TDD, other formats for utilizing cell or smart phone technology, telephony antenna distributions, and/or any combinations thereof] and includes the use of satellite, microwave technology, the internet, cell tower, telephony, and/or public switched telephone network lines. LTE (long-term evolution) utilizes the 4G standard and consists of LTE Categories 3 and 4 (100-150 Mps download) using bands 2, 4, 6, 13, 17, and 25), LET Advanced Categories (AC) 6 (300 Mps download) using bands 1, 2, 3, 4, 5, 7, 8, 12, 13, 17, 20, 25, 26, 29, 30 and 41), AC 7 (300 Mps download) which adds bands 14, 66, and 71), AC 12 (600 Mps) and AC 16 (1 Gps). Each carrier (T-Mobile, AT&T, Version provided similar or different services on one or more bands in 4G and LTE Advanced Pro Categories 18, 20 and 22 (1-2.5 Gps download). The 5G cellular has phase 1 consisting of Snapdragon modem X50, X55, X60 and X62 (with 2+ Gbps download) which can be in a coaxial relationship with 4G Categories (20 and 22). Phase 2 G5 cellular consists of Snapdragon modem X72 and X75 (with 3.4 Gbps download) and has bands n1, n2, n3, n5, n7, n8, n12, n13, n14, n81, n20, n25, n26, n28, 29, n30, n38, n40, n41, n48, n66, n70, n71, n75, n76, n77, n78 and n79. 5G is further offered as non-standalone cellular technology which coexists with a 4G channel (Phase 1) or standalone which is purely 5G cellular technology (Phase 2). An eSIM cellular technology can be utilized with the different carrier services. With one or more wireless water meters in communication with one or more communication hubs, a cellular network can be established whereby multiple or numerous water meters are in communication with multiple or numerous communication hubs.

In the most efficient situation, one of more wireless water meters can communication with one (or more) communication hubs using an ISM (industrial, scientific, and medical) bands or Wi-Fi versions 3/4/5/6/6e, WiFi7, Li-Fi, LoRa, Sigfox, Ultra Narrow Band, 6LowPAN, NB-IoT, M-Bus, WIMAX, Amazon Sidewalk. The communication hubs can function as repeaters or access points. The communication hub can utilize the cellular network and can use the internet, other private or commercial networks to transfer data to one or more remote computers with one or more databases. In most instances, the download speed is greater than the upload speed. The upload speed is slower than downloading files because most high-speed Internet connections, including cable modems and DSL, are asymmetric and are designed to provide much better speed for downloading than uploading. Since most users spend much more time downloading (which includes viewing web pages or multimedia files) than they do uploading, high speed Internet providers have designed their systems to give priority to downloading. The communication hub can use the upload section cellular or internet because sending data is generally less intrusive or burdensome and uses less bandwidth that uploading video formats. The communication hub can have software that monitors for upload (and download speed) utilizing the LTE (long-term evolution) utilizes the 4G standard and consists of LTE Categories 3 and 4 (100-150 Mps download) using bands 2, 4, 6, 13, 17, and 25), LET Advanced Categories (AC) 6 (300 Mps download) using bands 1, 2, 3, 4, 5, 7, 8, 12, 13, 17, 20, 25, 26, 29, 30 and 41), AC 7 (300 Mps download) which adds bands 14, 66, and 71), AC 12 (600 Mps) and AC 16 (1 Gps). Each carrier (T-Mobile, AT&T, Version provided similar or different services on one or bands in 4G and LTE Advanced Pro Categories 18, 20 and 22 (1-2.5 Gps download). The 5G cellular has phase 1 consisting of Snapdragon modem X50, X55, X60 and X62 (with 2+ Gbps download) which coaxial with 4G Categories 20 and 22. Phase 2 G5 cellular consists of Snapdragon modem X72 and X75 (with 3.4 Gbps download) and has bands n1, n2, n3, n5, n7, n8, n12, n13, n14, n81, n20, n25, n26, n28, n29, n30, n38, n40, n41, n48, n66, n70, n71, n75, n76, n77, n78 and n79. 5G is further offered as non-standalone cellular technology which coexists with a 4G channel (Phase 1) or standalone which is purely 5G cellular technology (Phase 2) and find the best performance bands, or combine bands, for sufficient transfer of water use data. The communication hub can have internal antenna, or an external directional or omnidirectional antenna to increase wireless gain. Using a plurality of water meters transmitting water data using ISM or other wireless technology to communicate with a communication hub which is using cellular communications, the cost of cellular communications is divide between the number of meshed wireless water meters permitting costly cellular communications. When using mesh technology with a plurality of wireless water meters communicating with one (or more) communication hubs flow control is more critical. Handshaking technology is also referred to as “flow control” because the process establishes the rules for managing the flow of data between the wireless water meter and the communication hub. The process functions whereby two devices on a network have an initial dialog before water use data is transferred. This initial dialog is crucial because it is where the wireless water and the communication hub define the rules of engagement, such as when and how to send data, and how fast of a uploading transmission is required. This is important, for example, when twenty wireless water meters communication with one communication hub and each morning when all twenty resident home starts a shower at 7:00 a.m. The handshaking technology and mesh technology must communicate together and compartmentalize the transfer of water use data when multiple wireless transfer occur at the same time. This requires the wireless water meter to have some software instructions to participate with the handshake technology and have enough memory storage capability to store water use data for a period so water use data is not lost. The communication hub has intelligent software that determines the mesh and handshaking rules and using software algorithms or artificial intelligence that learns the water use among the exemplary twenty residences and optimizes the meshing and handshaking protocols. The components of the cellular network with water meters, cellular radios, communication hub and network systems can be sold in individual parts.

Cell or smart phones, computers, or similar apparatuses includes all cellular phones and mobile electronic communication devices using access and format telecommunication methods (with cellular equipment, public switched telephone network lines, satellite, and/or mesh technology); personal digital assistants (PDAs); tablets (refers to all current and variants, revisions, and generations of the APPLE®, SAMSUNG®, HP, ACER®, MICROSOFT®, NOOK®, GOOGLE®, SONY®, KINDLE® and other tablets manufactured by these and other manufacturers); APPLE IPOD TOUCH®; smart or internet capable televisions; wireless timepieces or wireless watches; other electronic apparatuses with Wi-Fi, Wi-Fi versions 3/4/5/6 and wireless capability; remote computers and controllers having internet, cellular technology, Wi-Fi, Wi-Fi versions 3/4/5/6, ZigBee, Bluetooth, Bluetooth low energy (BLE), and any combinations thereof.

LoRa, also known as LoRaWAN (and referred to as “LoRa” herein) comprises a low-power wide area and long-range network protocol based on LoRa technology for IoT devices, and LoRa networks and machine-to-machine (M2M) applications. LoRa uses chirp spread spectrum (CSS) technology originally developed by the company Semtech. It focuses on secure bi-directional communications in an asynchronous protocol that is designed for long wireless range with extended battery life. LoRa manufacturers use the entire allocated bandwidth to broadcast a communication or signal, making the LoRa protocol robust to minimize channel noise and excellent at handling interference and overlapping networks. The LoRa protocol-provides interoperability among smart devices without the need for a complex local installations. All communication is generally bi-directional or duplex format, but also supports multicast operations for enabling software upgrades or mass distribution messages to reduce the on-air communication time. Communication between end-devices and gateways is spread out on different frequency channels and data rates. The selection of the data rate is a trade-off between communication range and message duration. Due to the spread spectrum technology, communications with different data rates do not interfere with each other and create a set of “virtual” channels increasing the capacity of the gateway. LoRa data rates range from 0.3 kbps to 50 kbps. To maximize both battery life of the end-devices and overall network capacity, the LoRa network server can manage the data rate and radio frequency output for each end-device individually by means of an adaptive data rate (ADR) scheme. The LoRa technology offers high penetration, low bandwidth, low energy, long range, and secure data that is gaining significant access into the IoT networks.

The LoRa wireless system makes use of the unlicensed frequencies below 1 GHz that are available worldwide:
868 MHz for Europe
915 MHz for North America
433 MHz band for Asia

Using lower frequencies than those of the 2.4 or 5.8 GHZ ISM bands enables much better coverage to be achieved especially when the nodes are within buildings enabling superior penetration of tall buildings and solid walls. With the water meter in communication with one or more communication hubs, a LoRa or LoRaWAN network can be established whereby multiple or numerous water meters are in communication with multiple or number communication hubs. The communication hubs can function as repeaters or access points. The LoRa or LoRaWAN network can use the internet, other private or commercial networks to transfer data to one or more remote computers with one or more databases. The components of the LoRa or LoRaWAN network with water meters, LoRa radios, network systems and monitoring facilities can be sold or leased individually.

With traditional Wi-Fi, most networks were designed on the range delivered by 802.11 standard operating frequencies 2.4 and 5.8 GHz and protocol for distance and performance. Newer Wi-Fi technology being developed is known as Wi-Fi3. In the foreseen near future, companies like Edgewater Wireless will develop and market Wi-Fi3 powered technology that will deliver reliable, high-capacity indoor and outdoor Wi-Fi wireless communication and protocols for high-density environments. The high channel density will enable multiple channels of a single chip meaning aggregate output on a single Wi-Fi3 enabled device will outperform traditional, single channel Wi-Fi technology, Thus, the fewer access points will deliver higher quality of service that can considerably lower the cost of deployment of IoT devices. Remote and rural infrastructure installations are easily achievable due to the extended network coverage and performance capabilities of Wi-Fi3. There are further improvements in Wi-Fi with Wi-Fi4, Wi-Fi5, Wi-Fi6 and Wi-Fi6e. Wi-Fi 6 is backward-compatible with earlier Wi-Fi standards but Wi-Fi 6E is not. Wi-Fi 6E creates a “fast lane” for compatible devices and applications, resulting in faster wireless speeds and lower latency. Lastly other improvements in Wi-Fi have been proposed and are under development. A new IEEE 802.11bb light communications standard is under development intended for emerging Li-Fi technology. Li-Fi uses infrared light instead of traditional radio signals like Wi-Fi to transmit networking data wirelessly. The potential for data transfer speeds that approach 100 times faster than traditional Wi-Fi, but the development is yet to be finally determined. This next generation of wireless networking breaks away from traditional radio signals reliant on standards like Wi-Fi6E and its upcoming successor, Wi-Fi7, in favor of harnessing an infrared ‘Li-Fi’ that is invisible to the human eye. Firms are already established and ready to embrace this emerging technology, with PureLiFi and Fraunhofer HHI among those companies promoting the light-based improvements over traditional Wi-Fi. Concurrently Wi-Fi7 under the official name 802.11 (with extremely high throughput) aims to achieve this by building on the groundwork of the last two Wi-Fi standards and extending them. From Wi-Fife, it borrows functions from such as Orthogonal Frequency-Division Multiplexing (OFDM) and BSS Coloring, which ensure that even in very large networks every device can transmit data with a minimal delay. Wi-Fi 6E also utilizes the 6 GHz transmission frequency, which facilitates fast Wi-Fi WLAN speeds. The advantages of Wi-Fi 7 are encouraging device manufacturers to advance this technology, such as AVM in Germany. With the water meter in communication with one or more communication hubs, a Wi-Fife, Wi-Fi7 and Li-Fi network can be established whereby multiple or numerous water meters are in communication with multiple or number communication hubs. The communication hubs can function as repeaters or access points. The Wi-Fife, Wi-Fi7 and Li-Fi network can use the internet, other private or commercial networks to transfer data to one or more remote computers with one or more databases. The components of the Wi-Fibe, Wi-Fi7 and Li-Fi network with water meters, Wi-Fi or Li-Fi radios, network systems and monitoring facilities can be sold or leased individually.

WiMAX refers to interoperable implementations of the IEEE 802.16 family of wireless-networks standards ratified by the WiMAX Forum. WiMAX was initially introduced to many international countries, WiMAX can be installed faster than other internet technologies because it can use low height towers with the support of non-line-of-sight coverage across an entire city or country. WiMAX transmitters can span several miles with data rates reaching up to 30-40 megabits per second (Mbps) (1 Gbps for fixed stations). Wireless WiMAX suffers like most other wireless technology that the further away from the source the slower their connection becomes. This means that while a user might attain 25 Mbps in one location, moving away from the WiMAX site can reduce that speed to 1 Mbps The WiMAX Forum has proposed an architecture that defines how a WiMAX network can be connected with an IP based core network, which is typically chosen by operators that serve as the Internet Service Providers (ISP) but can provide integration capabilities with other types of architectures. WiMAX Forum published three licensed spectrum profiles: 2.3 GHZ, 2.5 GHz, and 3.5 GHz, to establish standardization. With the water meter in communication with one or more communication hubs, a WiMAX network can be established whereby multiple or numerous water meters are in communication with multiple or number communication hubs. The communication hubs can function as repeaters or access points. The WiMAX network can use the internet, other private or commercial networks to transfer data to one or more remote computers with one or more databases. The components of the WiMAX network with water meters, WiMAX radios, network systems, and monitoring facilities can be sold or leased individually.

Ultra Narrow Band (UNB) refers to technology that transmits over a very narrow spectrum (for example less than 1 KHz) to achieve ultralong-range (5 km in the urban environment and 25 km+ in the suburb environment) for data communication between a sensor collection node transmitter and a communication receiving hub. By transmitting in a UNB channel, little power is required to transmit date over a considerable distance. UNB systems are frequently used in one-way, half duplex e.g., from collection node sensor(s) to an optional communication but can mimic two-way duplex communication when the receiver/sensor is sleeping most of the time and must open once a few times each hour to listen for signal commands or messages. With the water meter in communication with one or more communication hubs, a UNB network can be established whereby multiple or numerous water meters are in communication with multiple or number communication hubs. The communication hubs can function as repeaters or access points. The UNB network can use the internet, other private or commercial networks to transfer data to one or more remote computers with one or more databases. The components of the UNB network with water meters, UNB radios, network systems, and monitoring facilities can be sold or leased individually.

M-Bus technology is another wireless technology that competes with LoRa and LoRa WAN, Sigfox, and NB-IoT. M-Bus can provide date transmission with less interruptions, and robust interference protection. The Wireless M-Bus or Wireless Meter Bus is an open standard developed for very power efficient smart metering and Advanced Metering Infrastructure (AMI) applications and it is quickly spreading in Europe countries for electricity, gas, water and heat metering. A wireless M-Bus network is based on a star topology network with master and slave devices described in the EN 13757 standard which comprises a number of different operating modes: S, T, R and C (868 MHZ), F (433 MHZ) and N (169 MHz). Manufactures offer a range of sub-1 GHz transceivers, baluns and STM32 microcontrollers together with a large set of software libraries, including a free wireless M-Bus firmware stack for evaluation and sample implementation of a wireless M-Bus gateway in addition to hardware tools that enable quick development and deployment of wireless M-Bus networks. With the water meter in communication with one or more communication hubs, M-Bus network can be established whereby multiple or numerous water meters are in communication with multiple or number communication hubs. The communication hubs can function as repeaters or access points. The M-Bus network can use the internet, other private or commercial networks to transfer data to one or more remote computers with one or more databases. The components of the M-Bus network with water meters, M-Bus radios, network systems, and monitoring facilities can be sold or leased individually.

Amazon Sidewalk is a secure community network that uses Amazon Sidewalk Gateways (also called Sidewalk Bridges), such as compatible Amazon Echo and Ring devices, to provide cloud connectivity for IoT endpoint devices. Amazon Sidewalk enables low-bandwidth and long-range connectivity at home and beyond using Bluetooth Low Energy for short-distance communication and LoRa and FSK radio protocols at 900 MHz frequencies to cover longer distances. When Amazon Sidewalk Gateways opt to participate in the Sidewalk Network, Sidewalk endpoint devices located within the wireless range of this network can be used for applications such as sensing the environment or alerting when a specific condition or event occurs. Amazon Sidewalk supports a diversity of use cases, from connected sensors, utility meters or appliances in and around the home to trackers, tools, toys and monitoring devices that are used in and around neighborhoods and on the go. Amazon Sidewalk transfers data between Sidewalk endpoints and Sidewalk Gateways, and between Sidewalk Gateways and the AWS cloud. With the water meter in communication with one or more communication hubs, an Amazon Sidewalk Gateway network can be established whereby multiple or numerous water meters are in communication with multiple or number communication hubs. The communication hubs can function as repeaters or access points. The Amazon Sidewalk Gateway network can use the internet, other private or commercial networks to transfer data to one or more remote computers with one or more databases. The components of the Amazon Sidewalk Gateway network with water meters, Amazon Sidewalk Gateway radios, network systems, and monitoring facilities can be sold or leased individually.

NB-IoT is low power wire-area network standard developed for the 3GPP cellular network. It is considered a subset of cellular LTE with a narrowband of 200 KHz to communicate with internet of things.

6LOWPAN is an acronym that combines the new Internet Protocol (IPv6) with a sub 1 GHz frequency and low power wireless personal area network. The 6LOWPAN supports hundreds of hops for developing wireless mesh networks with high self-healing (node failure) and self-maintenance of mesh routes. The 6LoWPAN allows for small devices with limited transfer communication ability to transmit information wirelessly using the 6LoWPAN Internet Protocol. The 6LoWPAN architecture consists of a local network with routers/servers which utilizes one or more edge router(s) to connect to the access network. The one or more edge router(s), communicating with the internal servers, then provides the IoT sensor and applications to access to the internet. IP networking for low-power radio communication utilizes applications that need wireless internet connectivity at lower data rates for devices that can be designed with a limited footprint (form factor). The header compression mechanisms standardized in RFC6282 can be used to provide header compression within IPv6 protocol packets to be used over networks. IPv6 is also in use on the smart grid network enabling smart meters (water meters) and other devices to build a micro mesh network before sending the data back to the main remote servers with database for monitoring and billing operations system using the IPV6 backbone. Some of these networks run over IEEE 802.15.4 defined radios, and therefore these radios use header compression and fragmentation as specified by the RFC6282 standard. With the water meter in communication with one or more communication hubs, a 6LoWPAN network can be established whereby multiple or numerous water meters are in communication with multiple or number communication hubs. The communication hubs can function as repeaters or access points. The 6LOWPAN network can use the internet, other private or commercial networks to transfer data to one or more remote computers with one or more databases. The components of the 6LoWPAN network with water meters, 6LOWPAN radios, network systems, and monitoring facilities can be sold or leased individually.

Bluetooth Low Energy (BLE) refers to a newer version of standard Bluetooth. Standard Bluetooth was originally designed for continuous streaming of data applications. Both standard Bluetooth and BLE low energy operate in the 2.4 GHz ISM band. However, the BLE remains in a sleep mode constantly except for when a connection is initiated. The actual connection times are on a few milliseconds, unlike standard Bluetooth's continuous streaming. BLE short time connection allows for higher data transfer rates of approximately 1 Mb/s.

Cellular (3GPP) refers to a 3rd Generation Partnership that formulated the original release 8, 17 and 18 and the associated enhancements (9-14). The original release LTE 4G release 8 included high peak data rates, up to 300 Mbps in downlink and 75 Mops in uplink when using a 20 MHz bandwidth that includes high spectral efficiency and flexible bandwidths (1.4 MHZ, 3 MHz, 5 MHz, 10 MHz, 15 MHz and 20 MHz), 5 millisecond latency for IP packets in ideal radio conditions, simplified Architecture, orthogonal frequency-division multiple access (OFDMA) in downlink and Single-carrier frequency-division multiple access scheme (SC-FDMA) in uplink, all IP network, and using the multiple in and multiple out (MIMO) multiple antenna pattern.

The LTE Cat-MI and LTE (4G) Cat-MI technology is designed for Internet of Things (IoT) devices to connect directly to a 4G or 5G network, without the typical node/computer network that passes traffic from a local network to other networks or the Internet router (a gateway) and further while running on battery power. Devices can connect to 4G and 5G networks with microchips that are less expensive to fabricate because these microchips are half-duplex and have a narrower bandwidth. Such designed devices can enter a “deep sleep” mode called Power Savings Mode (PSM) and only wake up periodically while connected. Each cell sector must be connected to a network architecture, whether through a wired or wireless connection. 5G networks use orthogonal frequency-division multiplexing (OFDM) encoding. The 5G network interface will be designed for lower latency and greater flexibility that 4G LTE-M. The 5G networks have significantly more, smaller cells that can dynamically change it size and shape so 5G have to more intelligent than previous cellular technology. With existing macro cells. 5G is expected to boost capacity by utilizing wider bandwidths and advanced antenna technology.

The Wi-Fi versions 3/4/5/6/6e, WiFi7, Li-Fi, LoRa, Sigfox, Ultra Narrow Band, 6LowPAN, NB-IoT, M-Bus, WIMAX, Amazon Sidewalk, standard cellular technology, LTE-M cellular technology and 4G and 5G cellular technology can be used to form a network system. And the water meter base stations, the communication hub and network system can be divided into components or parts that can be sold separately.

A newer technology used with the cellular is the eSIM which stands for Embedded Subscriber Identity Module. The eSIM technology is a microchip or software code embedded or associated with the cellular radio component of the water meter. One of the advantages is that allows remote download of cellular data enabling the water meter to switch cellular service carriers at any time that is necessary such as during installation in various locations or upgrading to a different carrier. The eSIM technology also provides a higher level of security.

Iof Protocols can use 1) MQ Telemetry Transport (MQTT) which is a machine-to-machine or “Internet of Things” connectivity protocol on top of TCP/IP. It allows extremely lightweight publish/subscribe messaging transport, 2) Extensible Messaging and Presence Protocol is a communication protocol for message-oriented middleware based on XML. It enables the near real-time exchange of structured yet extensible data between any two or more network entities, 3) Constrained Application Protocol (CoAP) is a specialized web transfer protocol for use with constrained nodes and constrained networks in the Internet of Things. The protocol is designed for machine-to-machine (M2M) applications such as smart energy and building automation, 4) Advanced Message Queuing Protocol (AMQP) is an open standard application layer protocol for message-oriented middleware. The defining features of AMQP are message orientation, queuing, routing, reliability and security. AMQP mandates the performance of the messaging provider and client to the extent that implementations from different vendors are interoperable, in the same way as SMTP, HTTP, FTP, etc. have created interoperable systems, 5) THREAD is an IPV6-based, low-power mesh networking technology for IoT products, intended to be secure and future-proof specification that is available at no cost, but requires agreement and continued adherence to an end user license agreement, 6) Zigbee is an IEEE 802.15.4-based specification with a group of high-level communication protocols used to create personal area networks with small, low-power digital radios, such as for home automation, medical device data collection, and other low-power low-bandwidth needs, designed for small scale projects which need wireless connection. Zigbee is a low-power, low data rate, and close proximity wireless ad hoc network, 7) Z-wave is a wireless communications protocol used primarily for home automation but applicable to IoT applications. It is a mesh network using low-energy radio waves to communicate from device to another device, allowing for wireless control, 8) Data Distribution Service (DDS) is an Object Management Group (OMG) machine-to-machine standard that aims to enable scalable, real-time, dependable, high-performance and interoperable data exchanges using a publish-subscribe pattern, 9) Hypertext Transfer Protocol (HTTP) is an application protocol for distributed, collaborative, hypermedia information systems. HTTP is the foundation of data communication for the World Wide Web, where hypertext documents include hyperlinks to other resources that the user can easily access and/or 10) a custom designed protocol.

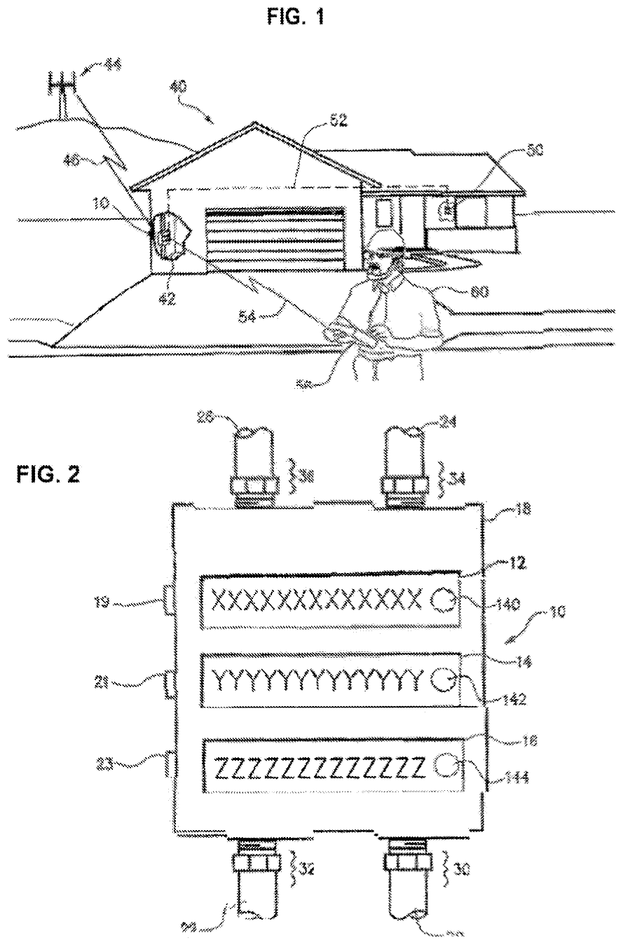

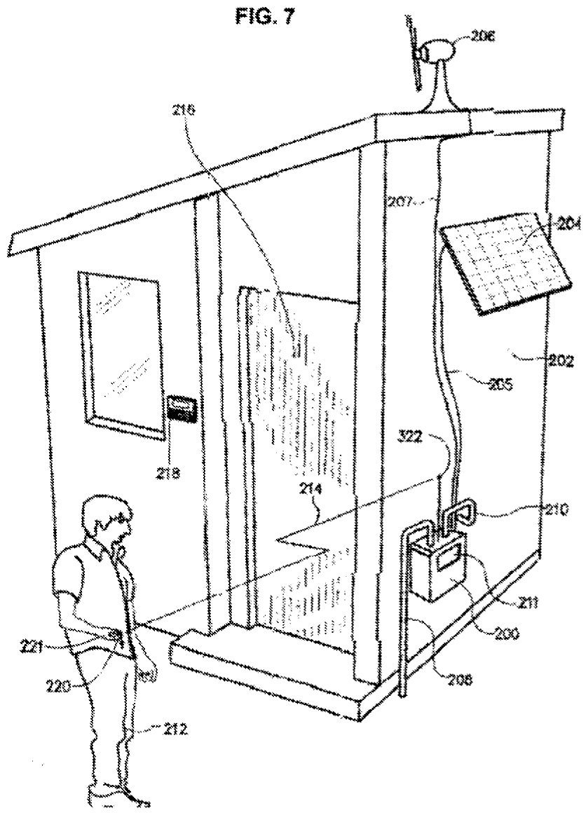

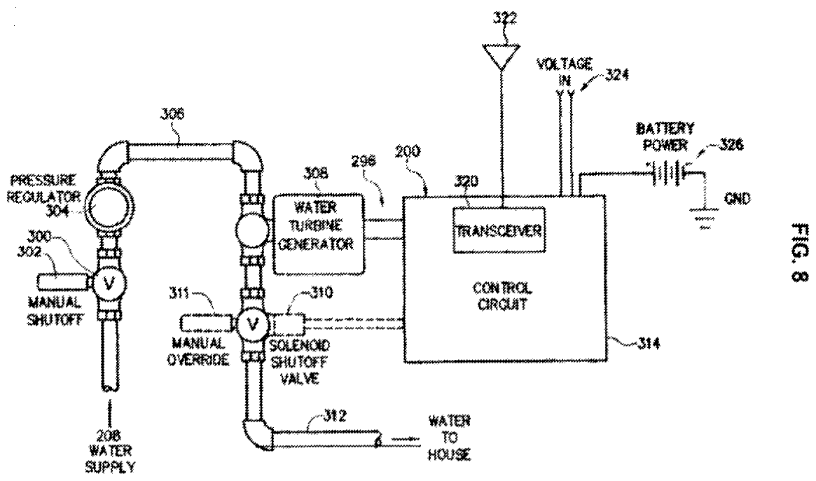

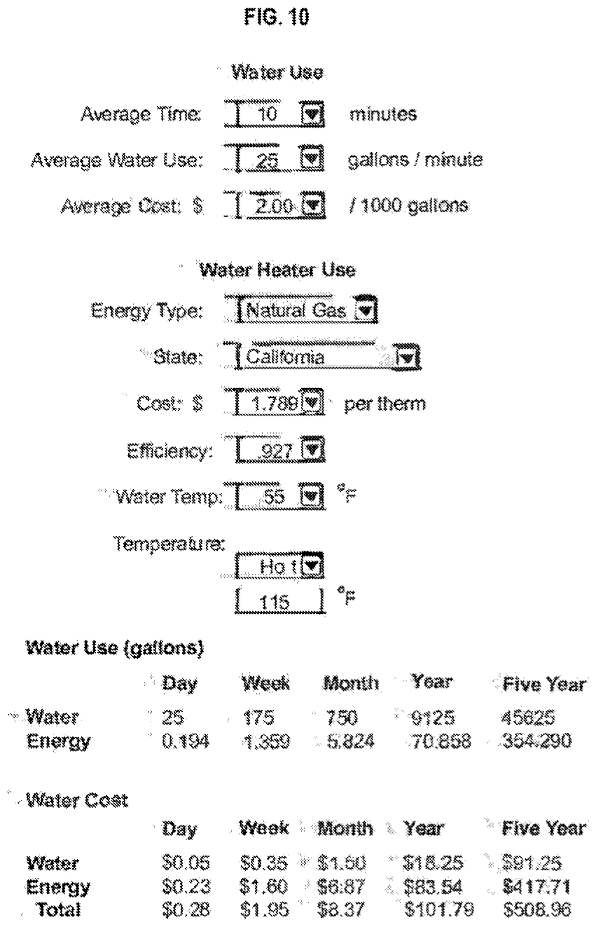

Referring now to the drawings and particularly to FIG. 1, shown is an illustrative view of the water meter and leak detection system 10 (126 shown in FIGS. 6 and 200 shown in FIG. 7) connected in series to the water supply lines in an appropriate location for local water monitoring 42 and for monitoring water use and leak detection within a private or public property 40. For accurate measurements of water use, the present invention can be installed in the standard water meter location or installed between the pressure reducing valve and the civil, commercial, governmental, or municipal supply water source(s) and before any distribution lines. It is also anticipated by the Applicant that the water meter and leak detection system 10 (126 shown in FIGS. 6 and 200 shown in FIG. 7 can be used on wells and in situations where the water source is not obtained from civil, commercial, governmental, or municipal operations. The water use and leak detection apparatus 10 (126 shown in FIGS. 6 and 200 shown in FIG. 7) can have a sampling rate to upload or download water and energy use on various frequencies, e.g. one every 1-20 seconds (for monitoring water flow events), once per minute, once per hour, once per day, once per any frequency, or preferably can send information upon sensing the initiation of water flow until the water flow is stopped (defined herein as an “water event use” or “water event use basis”). Monitoring on a water flow event basis allows for a quantitative analysis using software instructions, algorithms, and artificial intelligence to learn the daily, weekly, or monthly water use patterns and frequencies of a specific private or public property to improve identification and evaluation of water use characteristics and improved leak detection system. The water parameter information can be viewed on a custom display/recorder screen 50, or cell or smart phones, computers, or similar apparatuses having an application program of APP (shown in FIGS. 10-13).

The water parameter information can also be uploaded, either with the use of an optional communication hub 477 to an internet router using wired or wireless technology which transmits the data through remote servers (for example, Amazon Web Services, Oracle Cloud, Microsoft Azure Cloud) and associated database(s) or alternately, through a private or commercial network with privately own servers to a remote computer operation center or web-based company.

Also shown in FIG. 1 is a wireless (or wired) communication means 52 from the water meter and leak detection system 10 (126 shown in FIGS. 6 and 200 shown in FIG. 7) for transmitting water use, water quality and leak detection information and/or data. The wireless (or wired) technology 52 can communicate with a conveniently located remote display 50 in a location for review by a private or public property owner, user, or responsible individual(s). Remote display 50 can be a custom apparatus or TV, computer, iPad, or another conveniently available display technology. All wireless (or wired) communications should preferably be in a half or full duplex format. Since the wireless communication means 52 is in relatively proximity to the water meter and leak detection system 10 (126 shown in FIGS. 6 and 200 shown in FIG. 7), the wireless means can consist of Bluetooth or BLE, Z-wave, ZigBee, 6LOWPAN, or Wi-Fi, Wi-Fi3/4/5/6, Wi-Fi7, Li-Fi or similar technology that can communicate with router technology. It is anticipated that WIMAX, LoRa, Ultra Narrow Band (UNB), Sigfox, M-Bus, Amazon Sidewalk Technology, cellular, 3GPP, and/or cellular LTE-M, 3GPP, 4G, and 5G technology might be necessary for longer distance communication using long range, low power, and/or high-density technology that can communicate with one or more communication hubs 477. This electronic communication comprises, in part, a segment of the internet of things (IoT) concept. The wireless (or wired) communication means 52 can also electronically communicate with a local router, which uses the internet and remote computer servers (cloud technology) or web-based companies to provide remote access of the water data. Alternatively, wireless communication can transmit through a private or commercial network with privately own servers to a remote computer operation center.

Also shown in FIG. 1 is another wireless communication means 54 from the water meter and leak detection system 10 (126 shown in FIGS. 6 and 200 shown in FIG. 7) for communicating water use and/or water quality information to a governmental, civil or municipal employee or individual 60 using a second custom remote display/recorder 56 for civil, commercial, governmental, or municipal operators/representatives. Since the wireless communication means 52 is not relatively close to the water meter and leak detection system 10 (126 shown in FIGS. 6 and 200 shown in FIG. 7), this wireless technology should consist of a longer-range technology such as Wi-Fi version 3/4/5/6, WiFi7, Li-Fi, LoRa, Sigfox, Ultra Narrow Band, 6LowPAN, NB-IoT, M-Bus, WIMAX, Amazon Sidewalk, standard cellular technology, LTE-M cellular technology, 3GPP, 4G and 5G cellular technology. However, Bluetooth and BLE, ZigBee, Z-wave or similar wireless protocols are also possible as these technologies are improving in range and security measures and are offering better capabilities.

FIG. 1 shows another wireless communication 46 that is designed to communicate information or data utilizing cellular format technology with offsite central monitoring using cellular or other telephone lines including satellite or microwave technology, the internet, cell towers, telephone lines, or similar technologies. Such cellular format could be CDMA, GSM, 3GPP, LTE-M and 5G or another cellular format. It is anticipated that the wireless communication technology 46 can transmit information to a remote database, which communicates with a registered cell or smart phone, computer, or similar apparatus for displaying water use and leak detection data. The wireless communication technology 46 should include specific identification information e.g., the private or public property address. The wireless communication technology 46 can send data on various frequencies, e.g., once per minute, once per hour, once per day, once upon any frequency, or preferably upon a water event basis. The wireless communication technology can also send information upon sensing the observation of a leak condition, e.g., alarm situation, to the registered owner or user of a cell or smart phone, computer, or similar electronic apparatus. Alternately, continuous data monitoring can be stored in a data module in the water meter collection node and periodically transferred wirelessly to a remote computer or server as described herein. The water event basis monitoring can minimize the use of wireless signals within the private or public property or building(s), conserving energy, minimizing the interference with other wireless devices, and reduce the exposure of wireless energy to individuals.

Furthermore, the wireless communication 46 can consist of two-way transmission, commonly known as half (both devices can transmit the signal, but one at a time) or full (both devices can transmit the signal at the same time) duplex transceiver technology, such that the water meter and leak detection system 10 (126 shown in FIGS. 6 and 200 shown in FIG. 7) can transmit and receive electronic signals with a remote station, cell or smart phone, computer, or similar apparatus. The wireless communication 46 can also comprise a Radio Frequency (RF) mesh-enabled or point-to-point device (meters, relays) technology that is connected to several other mesh-enabled or point-to-point devices, which function as signal repeaters, relaying the data to an access point. The access point device aggregates, encrypts, and eventually transmits the data back to a municipal or government agency over a secure third-party private or commercial network. The resulting RF mesh or point-to-point network can span large distances and reliably transmit data over rough or difficult terrain. If the water meter and leak detection system or optional communication hub 477 transmitter drops out of the network, its neighboring water meter and leak detection system or optional communication hub 477 will find another route. In this meshing technology the communication hub 477 can also serve as a repeater apparatus receiving water data and transmitting water data to also provide longer wireless range capability. The mesh or point-to-point technology continually optimizes routing to ensure information is passed from its source to its destination as quickly and efficiently as possible. When the wireless communication 46 is being used, the water use data can be routed through a Bluetooth, Bluetooth low energy (BLE), Wi-Fi, Wi-Fi3/4/5/6, W-Fi7, Li-Fi, ZigBee, Z-wave, LoRa, Sigfox, 6LOWPAN, WiMAX, Ultra Narrow Band (UNB), NB-IoT, M-Bus, Amazon Sidewalk technology or other wireless technology using a local router/server or private or commercial network that transfers the water use data over the internet and remote servers (cloud technology) or a web-based company. Signals and/or data can also be transferred by standard cellular format, 3GPP or LTE-M, 4G and 5G cellular technology (using a cell phone, smart phone, computer, or similar electronic apparatus) from cellular towers to remote servers or cloud service companies and then over the internet to a local router/server in a private or public property. The wireless communication 46 can be either half duplex and/or full duplex two-way transmission.

The wireless communications 52, 54 and 46 are preferred to transmit, upload, or download water parameter data or information via a secure wireless communication network. It is anticipated that the wireless communication 54 can be received by a moving vehicle or can communicate with cell phone towers 44 and cellular technology using wireless communication 46. The electronic communication(s) comprises, in part, a segment of the internet of things (IoT) concept. The wireless communication 54 or wireless communication 46 can also electronically communicate with a local router/server which uses the internet to communicate with remote computers (cloud service company) for recording water use data and to allow remote access of the water use data. Such remote computers can be provided by a large commercial cloud computer company or a web-based company.

It is anticipated that the wireless communications 54 and 46 and the wireless or wired communication 52 utilizing wired technologies (X10, UPB etc.) can be used with the water meter and leak detection system 10 (126 shown in FIGS. 6 and 200 shown in FIG. 7) in any combination. For example, the present invention's collection node can use Bluetooth, Bluetooth Low Energy (BLE), Wi-Fi version 3/4/5/6, WiFi7, Li-Fi, LoRa, Sigfox, Ultra Narrow Band, 6LowPAN, NB-IoT, M-Bus, WIMAX, Amazon Sidewalk, standard cellular technology, LTE-M cellular technology, 3GPP, 4G and 5G cellular technology to communicate with a custom display device 18, 56, 110 or with a cell or smart phone, computer, or similar apparatus 400. The collection node can also communicate with a local wireless router or through a private or corporate network system to a private, commercial, or government remote computer(s) or server(s). The collection node can also be connected by wired technology directly or through X10, UPB or HART Communication Protocol to communicate with a device such as a smart speaker hub or router. The collection node can also connect directly to a private or commercial network system or to a router that communicates with the internet, all linked to a private, commercial, or government remote computer(s) or server(s). The collection node can also have a standard, 3GPP or LTE-M and 5G cellular technology to communicate wirelessly to the private, commercial, or government remote computer(s) or server(s). Also, one or more collection nodes can wirelessly communication using Wi-Fi version 3/4/5/6, WiFi7, Li-Fi, LoRa, Sigfox, Ultra Narrow Band, 6LowPAN, NB-IoT, M-Bus, WIMAX, Amazon Sidewalk, standard cellular technology, LTE-M cellular technology, 3GPP, 4G and 5G cellular technology to one or more communication hubs 477 (with point-to-point or meshing technology) whereby the communication hub 477 is either hard wired or uses Wi-Fi (Wi-Fi versions 3/4/5/6) to communicate with a wireless router (or cable modem) or a hardwire PoE connection to communication over the internet to a private or commercial remote server. These are just a few examples of combinations using various wired and wireless technologies with the water meter and leak detection system.

Power over Ethernet (PoE) is a technology that allows networked devices such as wireless access points, IP cameras, and VoIP phones to receive both data and power over a single Ethernet cable. This eliminates the need for separate power supplies or outlets, making it easier to install and manage network devices. Any network device that is powered by PoE is referred to as a powered device, or PD. The development of the more powerful IEEE 802. 3bt standard has allowed for more power-hungry applications such as PoE LED lighting and High-Speed HD Outdoor PoE network cameras with climate control. Power sourcing equipment (PSE) can send power and data over the Ethernet cable to a PoE device (PD). PSE devices are generally classified as either termed endpoint or midpoint. Endpoint utilizes a POE Network Switch and since the switch can power the connected devices, there is no need for an additional power source for the PD. In the midpoint mode, when a non-PoE-enabled LAN, network switch or router is to be used with a PD, then a power source needs to add power to the connection. This device is placed between (midpoint) the non-POE LAN, network switch or router and the PD. A very common device used with as the PoE midpoint is a POE injector. There are several standards for transmitting PoE cabling, including POE IEEE 802.3af with 15 watts of power, POE IEEE 802. at with 30 watts of power, PoE 802. 3bt Type 3 (also known as 4PPOE) with 60 watts of power and PoE 802. 3bt Type 4 (also known as ultra PoE) with 100 watts of power. A LAN, network switch or router can send data to a POE switch within a distance of about 320 ft that adds power to the data source, or a LAN or network switch or router can send data to an intermediary POE injector the adds power to the data source. This technology can be used to power the recharged batteries or alternately with the 802.3bt standards may just fully power the water meter without any batteries.

Wireless communication means 46, 52 and 54 preferably utilize encryption, authentication, integrity and/or non-repudiation techniques to provide a secure transfer of the water information from the water meter and leak detection system 10 to the first custom display/recorder apparatus 50, to the second custom display/recorder apparatus 56 and/or to the cell or smart phone, remote computer, web portal or similar apparatus 400. Also, wireless communication means 46, 52 and 54 should include specific identification information e.g., property address, IP address. The wireless communication means 46, 52 and 54 can send data on various frequencies, e.g., once per minute, once per hour, once per day, or preferably will send information on a water event basis to a first remote 50, a second remote 54 or a remote computer/database which will allow access to registered owners or users of cell phone, smart phone, computer, or similar electronic apparatus 400. Furthermore, wireless communication means 46, 52 or 54 can send data or information upon the sending of a request signal. The request signal can be generated by, for example, the pushing of a requesting button located on the first 50 remote, the second 56 remote or the cell phone, smart phone, or similar apparatus 400 that transmits a request for water use and water quality use information or data to the water meter and leak detection system 10 (126 shown in FIGS. 6 and 200 shown in FIG. 7). The use of the request signal can minimize the use of wireless signals within the private or public property (ies) building, conserving energy, minimizing the interference with other wireless devices, and reduce the exposure of wireless energy to individuals.

The water meter and leak detection system should be able to reliably and securely communicate the information collected to a remote central computer location. Difficult environments and distant locations for water meter installation can present wireless communication challenges. Solutions include using cell technology networks, satellites, licensed RF technology, licensed and unlicensed RF combined, and/or wired power lines. Additional remedies include fixed wireless, mesh, or point-to-point (and hybrid) networks or any combinations thereof. There are several other potential network configurations possible, including the use of Wi-Fi (Wi-Fi versions 3/4/5/6), Wi-Fi, Li-Fi and other internet related networks. To date, no one solution seems to be optimal for all applications. Rural municipalities such as mountainous regions or areas ill-served by wireless and internet companies have very different wireless communication issues than urban or established area utilities.

TCP/IP technology has become a common communication and management platform for sensor to device applications, so software developers can utilize multiple communication systems while using TCP/IP technology. TCP/IP is a combination of two technologies where TCP comprise the fourth layer, and IP comprises the third layer, of the network and transport sections of the Open Systems Interconnect model (OSI model). Wireless technology such as LoRa, Sigfox, WIMAX, 6LOWPAN, UNB, NB-IoT, M-Bus, Wi-Fi, Wi-Fi3/4/5/6 (with Wi-Fi extenders) Wi-Fi7, Li-Fi, Amazon Sidewalk technology, Cellular 3GPP, and/or LTE-M, 4G and 5G, Bluetooth and BLE, ZigBee, Z-wave or similar wireless protocols or other communication technologies using the TCP/IP technology to transfer or download water data from a private or public property or used to upload data, information or software updates to the water meter and leak detection system 10 (126 shown in FIGS. 6 and 200 shown in FIG. 7).

FIGS. 10-13 show a cell or smart phone, computer, or similar apparatus 400 running an “APP” or a sequence of “APP” pages that show, in a pie chart, bar chart, or other format, the water uses of particular areas of the private and/or public property. The Water meter and leak detection system's flow rate sensor(s) and software calculate of the using the water flow rate, water use duration, and total volume of water to differentiate water use devices (e.g., shower, faucet, bathtub, toilet, washing machine, water heater, dishwasher, and outside irrigation system) can be to show the water uses. Other outdoor water uses such as pool or hot tub or water fountain water maintenance can be included for water use monitoring. The addition of an acoustic sensor can monitor valve movement, vibration, and noise patterns (sound and pressure patterns) which can sense water valve position or movement, with the water meter and leak detection system can provide more specific differentiation of water use devices. Using AI software technologies, the acoustic sensor could be calibrated to monitor water rate flow and water pressure.

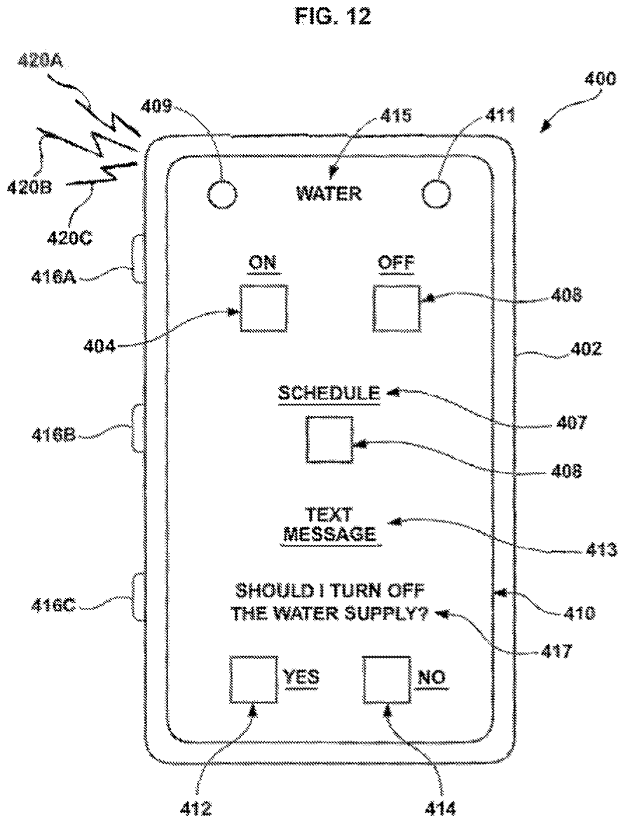

FIG. 12 shows the water meter and leak detection system APP, which manages the water control valve mechanism enabling one to turn the water supply on/off, to program a water on/off schedule, and to receive notification of a leak condition with the option to remotely turn off the water supply. The water meter and leak detection system's flow sensor(s) 105 can communicate wirelessly or wired 101, 102, 103 with the microprocessor or microcontroller 84 that has software that learns about water usage at a private or public property or areas thereof. Calibration of the sensors with the water meter and leak detection system 10 (126 shown in FIGS. 6 and 200 shown in FIG. 7) can be initiated by pressing hard button 114, 116, and 118 and/or soft button activators 140, 144, and 146 on the water meter and leak detection system 10 (126 shown in FIGS. 6 and 200 shown in FIG. 7) or by the custom display and/or a recording apparatus 50, and/or by cell or smart phones, computers, or similar apparatuses 400 can be located remotely from the water meter and leak detection system 10 (126 shown in FIGS. 6 and 200 shown in FIG. 7).

In another embodiment, the multiple independent flow sensors 105 can be engaged to the main water supply, irrigation system, or water use devices such as washing machine, water heater, dishwasher, kitchen faucets, bathroom faucets, shower, and/or toilets, and any combinations thereof. Each independent flow sensor 105 sends a unique code to the microprocessor or microcontroller 84 for identification associated with the water use device. Each independent flow sensor 105 can communicate the water usage by wired or wireless communicating with a unique code to the water meter and leak detection system 10 (126 shown in FIGS. 6 and 200 shown in FIG. 7). The water data can be transferred to a remote device(s), e.g., remote display and/or a recording apparatus 50, 110 and/or cell or smart phones, computers, or similar apparatuses 400.

In another embodiment, which does not utilize an independent flow sensor at each water use device but rather a single flow sensor, can allow an owner/user to enter into a programmed “Water Use Device Calibration” Mode by pressing a specific hard or soft button on the water meter and leak detection system (collection node) 10 (126 shown in FIGS. 6 and 200 shown in FIG. 7) or touch screen display 80, or by sending an electronic signal from a display and/or recording apparatus 50, 110 and/or another remote device such as a cell or smart phone, computer, remote computer, web portal or one or more other electronic communication devices 400. The water flow sensors 105, optional pressure sensor(s), or temperature sensor and/or acoustic sensor(s) can monitor specific flow rates, flow durations, and total water use volumes, while the optional pressure sensor 65 can monitor unique pressure patterns, and the optional acoustic sensor can monitor unique sound patterns. Thus, a single set of localized sensors (flow rate sensor 105, optional pressure sensor 65, optional acoustic sensor, and/or optional temperature sensor) can be utilized and incorporated into the water meter and leak detection system 10 (126 shown in FIGS. 6 and 200 shown in FIG. 7). The optional pressure sensor(s) 65 and optional acoustic sensor(s) assist in identifying the specific water valve(s) for each water use device. During water use device calibration, the user turns on or cycles one water use device (e.g. washing machine, dishwasher, shower) for a time period and the water meter and leak detection system's calibration software calibrates or determines the water flow rate, water duration, and total water volume and, if applicable, utilizes pressure and acoustic sensors to observe patterns (movement and noise) to identify water valves for specific water use devices. The user continues this process for each water use device (e.g., mains water supply, irrigation system, washing machine, water heater, dishwasher, kitchen faucet, bathroom faucets, toilets) until the water use device(s) are calibrated and/or the specific water valve(s) are identified. The software can use calibration data from the collection node flow sensor for each water use device and record its water use signature (actual independent flow rates, variation of flow rate over time, water use duration, total volume used). To facilitate a factory specification software, water uses signatures and patterns which approximate irrigation, washing machine, water heaters, dishwashers, kitchen and bathroom faucets, and toilets each independent water use device, that can be modified by the artificial intelligence (AI) and software algorithms to be calibrated at the private and/or public networks) The optional pressure sensor(s) and optional acoustic sensor(s) observe movement, vibration, and noise patterns (sound and pressure patterns) to identify water valves for specific water use devices. The water use data can be communicated to a display and/or a recording apparatus 50, 110 and/or cell or smart phone, computer, server, remote computer, web portal or one or more other electronic communication apparatus 400 and the flow rates and water use for each water use device can be displayed appropriately.

It is anticipated by the Applicant that an “Automatic Learning Mode”, where the software learns about the users' water use at a private or public property, can be completed without the calibration steps. The Automatic Sensor Learning Mode utilizes artificial intelligence (AI) and other software to perform this operation. In this embodiment, a single sensor (e.g., flow rate sensor) 150, with optional pressure sensor(s) 65, optional acoustic sensor(s), and/or temperature sensor(s) 93 can be located within or near the water meter and leak detection system 10 (126 shown in FIGS. 6 and 200 shown in FIG. 7). Since independent water valves have unique pressures and sounds patterns when being closed or opened, the optional pressure sensor 65 and optional acoustic sensor can be incorporated into the water meter and leak detection system 10, 126 and function to assist in identifying the water valve(s) of a specific water use device(s). A user can enter into a programmed “Automatic Learning Mode” by pressing a specific hard or soft button on the water meter and leak detection system 10 (126 shown in FIGS. 6 and 200 shown in FIG. 7) or touch screen display 80 or by sending an electronic signal from a display and/or recording apparatus 50, 110 and/or another remote device such as a cell or smart phone, computer, remote computer, web portal, or one or more other electronic communication device 400. Such operation initiates the software to monitor the water use that occurs during the next days, weeks and/or months and, during this period, the learning AI software enters an aggressive learning phase. In this Learning Mode, the water meter with leak detection system automatically tracks water use parameters over the period until enough information is observed. With the Automatic Learning Mode, the water meter and leak detection system 10 (126 shown in FIGS. 6 and 200 shown in FIG. 7) monitors water use, optional water pressure, optional acoustic sensors, and temperature to get water signatures or patterns from water use devices. Using the water flow rate sensor, flow rate, variation of flow rates over time, total volume, and duration of flow parameters can be used for signatures or patterns. The optional pressure sensor, temperature sensor and acoustic sensor can supplement the water meter and leak detection system 10 (126 shown in FIGS. 6 and 200 shown in FIG. 7) signature or patterns to further characterize water use devices. The software can also track water use temporal patterns during a day or week period to further enhance the signature and pattern of a public or private building or structure. For example, in a private residence, many showers might occur during the early morning hours as individuals are getting ready for work or school. During weekends, the showers occurrence might shift to a later period, and washing machine and dishwasher water cycles might occur. The optional pressure and acoustic sensor(s) observe movement, vibration, and noise patterns (sound and pressure patterns) to identify water valves for specific water use devices. The Artificial Intelligent (AI) and software algorithms are used monitor the main water supply, irrigation system, and water use devices (e.g., washing machine, water heater, showers, dishwasher, kitchen and bathroom faucets). The AI software determines water use parameters, temporal characterization, property occupation and optionally monitor specific sounds and pressure patterns associated with water use (and non-water use) remembering water usage with consideration of time and day/week/month/year. The water meter and leak detection system transfers water data to a remote computer(s) or server(s) with database(s). Subsequently, the water data can be downloaded to a designated remote computer and database for registered cell or smart phone, computer or other electronic apparatus to gain access.

For example, after a period of time, Automatic Sensor Learning Mode using AI and other software can monitor a washing machine's range of water flow used and records the water use duration periods, water flow rate patterns (water flow rates for washing machine cycles and variations of water flow rates over time including rate of flow at onset of water flow and rate of flow at completion of water flow). The Automatic Sensor Learning Mode can use optional pressure sensor(s) for determining variations in pressure patterns and can use optional acoustic sensor(s) for identifying water valve movement and sounds when opening and closing and any vibrations during fully open valve with water flowing through the valve. In another example, when a toilet is flushed, the Automatic Sensor Learning Mode software recognizes the toilet water use pattern. If a bathroom faucet is turned on for hand washing, the software can identify the combination pattern of the toilet filling and the faucet water use. In this case an optional acoustic sensor can identify and differentiate the toilet and bathroom faucet water valves to more accurately monitor the water used by these different water use devices at the public or private property or structure. The Automatic Sensor Learning Mode software can analyze, record, and store actual independent flow rates, variation of flow rate over time, duration periods, temporal activities, optionally variations in pressure patterns (e.g. rate of flow at onset of water flow and rate of flow when turned off, and any variations during water flow duration, and optional acoustic sensor observing water valve characteristics to assign the signature or pattern of water use for the toilet and bathroom faucet. In another example, either during or following a shower, the Automatic Sensor Learning Mode software recognizes the shower water use pattern. A non-tankless hot water heater begins adding water to replenish the hot water used for the shower. The software can analyze, record and store actual independent flow rates, variation of flow rate over time, water use duration, variations in pressure patterns (e.g. rate of flow at onset of water flow and rate of flow when turned off, and any variations during water flow duration, and optional acoustic sensor to assign the pattern of water use to a particular water valve for the water use device shower and hot water heater. In another example, irrigation watering usually occurs at a regular temporal pattern (generally in the morning or evening hours). The Automatic Sensor Learning Mode software can analyze, record and store water flow rates and duration patterns for irrigation cycles. The automatic learning software could record and store actual independent flow rates, variation of flow rate over time, expected duration, variations in pressure patterns (e.g. rate of flow at onset of water flow and rate of flow when turned off, and any variations during water flow duration, and optional acoustic/sound frequency) to assign the pattern of water use to a particular flow sensor for the shower and hot water heater.

The water meter and leak detection system's water leak detection and monitoring capability can use wireless technology such Wi-Fi version 3/4/5/6, WiFi7, (with Wi-Fi repeaters, extenders) Li-Fi, LoRa, Sigfox, Ultra Narrow Band, 6LowPAN, NB-IoT, M-Bus, WIMAX, Amazon Sidewalk, standard cellular technology, LTE-M cellular technology, 3GPP, 4G and 5G cellular technology, Cellular 3GPP, and/or LTE-M and 5G, Bluetooth and BLE, ZigBee, Z-wave or similar wireless protocols or other communication technologies using the TCP/IP or other OSI technology to transmit an alarm or message to notify of leak condition(s) at a private or public property (ies). Leak notification can be provided via call to a registered or designated cell or smart phone, remote computer, web portal or similar electronic apparatus or the water meter and leak detection system can send an alarm(s) or message(s) directly to a governing utility or municipality.

To increase wireless range, include meshing technology and provide compatibility with wireless routers, the water meter and leak detection system 10 (126 shown in FIGS. 6 and 200 shown in FIG. 7) can be divided into two main components: 1) “collection node water meter” or “collection node”, which comprises a water meter with electrical circuitry with power source, CPU/microprocessor/microcontroller, sensor(s) (water flow sensor(s), optional temperature sensor(s), optional pressure sensor(s), and/or optional acoustic sensor(s)) and 2) a receiving hub or “communication hub 477, which is a receiving station having electrical circuitry, CPU, and one or more corresponding RF or cellular radios that communicate with the collection node water meter and one or more RF radios or cellular technology that communicate with a public internet or through a private network. The communication hub can perform as one or more repeater devices. Alternatively, the communication hub 477 can be hardwired or use wireless communication with an internet router. The water meter collection node's electric circuitry includes a generally corresponding low power long-range wireless radio with a power source that can be AC or DC voltage, one or more standard or rechargeable batteries (lithium ion), and/or super capacitors. The collection node can utilize a rechargeable one or more batteries and/or super capacitors that can be supplemented with a water turbine electric generator. The water meter collection node communicates wirelessly with the communication hub 477. The communication hub 477 has a CPU/microprocessor, electrical circuitry with a generally corresponding low power long-range wireless radio and a Wi-Fi radio (or hard wired) and a power source (battery or AC or DC voltage). In one embodiment, the communication hub 477 has a first wireless low power Wi-Fi version 3/4/5/6, WiFi7, Li-Fi, LoRa, Sigfox, Ultra Narrow Band, 6LowPAN, NB-IoT, M-Bus, WIMAX, Amazon Sidewalk, standard cellular technology, LIE-M cellular technology, 3GPP, 4G and 5G cellular technology 103 that has a corresponding radio that communicates with the water meter collection node (that likewise has a corresponding Wi-Fi version 3/4/5/6, WiFi7, Li-Fi, LoRa, Sigfox, Ultra Narrow Band, 6LowPAN, NB-IoT, M-Bus, WIMAX, Amazon Sidewalk, standard cellular technology, LTE-M cellular technology, 3GPP, 4G and 5G cellular technology. The communication hub 477 can have a second wireless Wi-Fi (Wi-Fi versions 3/4/5/6) radio that communicates with a wireless router or alternately RF and/or cellular radio that communicates with a private or public corporate network. The communication hub 477 can also have a limited range radio (Bluetooth, Bluetooth low energy (BLE), ZigBee or Z-Wave) designed to has local authentication pairing technology or update software procedures. The communication hub 477 can alternately be hard wired to the router and then the Wi-Fi (Wi-Fi versions 3/4/5/6) radio is not a necessary, or becomes a disabled component, of the electrical circuitry. The communication hub 477 includes software to process the transmissions from the collection node to at least one of Wi-Fi/router and wired/router that connected to the internet, or to a private or corporate network. The communication hub 477 need software instructs to process the authentication pairing or software updates. The water meter collection node can communicate with one or more water meters collection nodes and/or with one or more communication hubs 477 (using mesh technology and/or point-to-point technology). The wireless communication technologies utilizes authentication technology for pairing procedures between the base station and the at least one of the smart cell phone, mobile phone, PDA, tablet, remote computer, web portal, smart or internet capable television, wireless smartwatch and other electronic communication apparatuses associated with a water meter. The communication hub 477 can wireless communicate with one or more water meter collection nodes and/or with one or more communication hubs 477 (using mesh technology and/or point-to-point technology). The communication hub 477 can also serve as a repeater apparatus receiving water data and transmitting water data to also provide longer wireless range capability. The Wi-Fi and Wi-Fi 3, 4, 5, 6, or WiFi7, Li-Fi, LoRa, Sigfox, Ultra Narrow Band, 6LowPAN, NB-IoT, M-Bus, WIMAX, Amazon Sidewalk, standard cellular technology, LTE-M cellular technology, 3GPP, 4G and 5G cellular technology radios can be internal and will perform best and an antenna. The radio can be a part of the electrical circuit with an antenna comprising a strip on the electrical circuit or an external antenna apparatus. The radio and antenna apparatus can also be removable type that connects with a socket on the electrical circuit. The advantage of the removable radio and antenna apparatus is that wireless communication technologies can be changed, e.g. LoRa to Amazon Sidewalk, LoRa to cellular. Or the radio can be external to the electrical circuit and preferably connected by a wire connection or alternately using a low range wireless technology such as Bluetooth or Wi-Fi with the electronic circuitry. But using low range wireless technology suffers from having additional power demands. The external radio with external antenna will be used where particular blocking or reduction of wireless strength is confronted. A more typical situation is where the radio is either part of the circuit or a socket version, and the antenna connected by wire technology which is placed in a location where the antenna performs superiorly. For example, the water meter with electrical circuitry with connected radio are generally in a water meter box or pit that is below ground level. The antenna can be placed in the top of the water meter box exposed above ground level or even projecting from the top of the water meter box.

Some wireless routers support a form of point-to-point or bridging operation which could be used to transfer water parameter data from the water meter collection node to a communication hub 477. Cell phones receive and transmit electromagnetic waves that exist between 800 and 2400 megahertz and the most popular protocols are CDMA and W-CDMA, GSM, 3GPP, LTE-M and 5G, EDGE, HSPA and other generations. Other proprietary protocols can be used with the water meter and leak detection system 10 (126 shown in FIGS. 6 and 200 shown in FIG. 7), for example, ISM (industrial, scientific, and medical) bands. ISM bands are defined by the ITU-R in 5.138, 5.150, and 5.280 of the Radio Regulations. Countries' individual use of ISM bands may differ due to variations in national radio regulations. Communication devices using ISM bands must tolerate any interference from ISM equipment. In the United States, ISM bands use is governed by Part 18 of the FCC rules, while Part 15 Subpart B contains the rules for unlicensed communication devices including those that use the ISM frequencies. Part 18 rules restrict but allow access to using ISM for certain communications such as FCC licensed 450-470 frequencies. The ISM bands defined by the ITU-R or FCC licensed are:

| Frequency range [Hz] | | Center frequency [Hz] | |
|---|---|---|---|
| 6.765-6.795 | MHz | 6.780 | MHz |
| 13.553-13.567 | MHz | 13.560 | MHz |
| 26.957-27.283 | MHz | 27.120 | MHz |
| 40.66-40.70 | MHz | 40.68 | MHz |
| 433.05-434.79 | MHz | 433.92 | MHz |
| 450-470 | MHz | 460 | MHz |
| 902-928 | MHz | 915 | MHz |
| 2.400-2.500 | GHz | 2.450 | GHz |
| 5.725-5.875 | GHz | 5.800 | GHz |
| 24-24.25 | GHz | 24.125 | GHz |
| 61-61.5 | GHz | 61.25 | GHz |
| 122-123 | GHz | 122.5 | GHz |
| 244-246 | GHz | 245 | z |

Many newer internet protocols have been developed commonly known as an application programming interface (API). An API for website usage is a code that allows two software programs to efficiently communicate with each other. The API defines the proper way for a programmer or developer to write software instructions in the program separate from an operating system or other application. One such API is the RestAPI system which aims for fast performance, reliability, and the ability to grow, by re-using components that can be managed and updated without affecting the commercial system. A RestAPI uses HTTP requests to GET, PUT, POST and/or DELETE data or send control signals. A RestAPI, also referred to as a RESTful web service, is based on the representational state transfer (REST) technology, an architectural style and approach that has communications often used in web service development. REST technology is generally preferred API protocol because it leverages less bandwidth, making it more suitable for internet and IoT usage. The REST is used by web browser and can be thought of as the language of IoT. With cloud company services on the rise, APIs are being developed to facilitate communication with web services, REST is a logical choice for building APIs that allow users to connect and interact with cloud services and web-based companies.

ResAPI has a uniform interface, which serves as the interface between clients and servers. The uniform interface simplifies and decouples the REST architecture, which enables the clients and servers to evolve independently. Four guiding principles of the uniform interface are described below.

First by using resources for identified using Uniform Resource Identifiers (URIs) as resource identifiers. The identifiers are separated from the representations that are returned to the client. The commercial or private server does not transfer data directly from the database, but rather, utilizes HTML, XML or JSON code that is designed to represent database records expressed in variable width character encoding, depending on the details of the structured query language (SQL) request and the server implementation.

Second, a representation of a resource, including any metadata attached, and the software will verify that it has enough security information to modify or delete the resource on the server only under proper server permissions.

Then, a third process where each message includes enough information to describe how to process the message invoking specified content by an Internet media type. Responses also explicitly indicate their cache-ability.

On the fourth process the delivery of data or information utilizes SQL or non-SQL parameters, body content or headers, and requested URI for transmission communications. Computer or servers respond via body content, response codes, and response headers to the request. Hypermedia as the Engine of Application State (HATEOAS) links are contained in the returned body (or headers) to supply the URI for retrieval of the database objects from a remote computer server(s) with database(s).

Stateless or statelessness of the REST architectural style and associated RestAPI protocol handles any sent requests, whether as part of the URI, query-string parameters, body content, or headers. The URI uniquely identifies the resource and the body content contains the state (or state change) of the resource. After server/computer processes the request, the appropriate state (or the piece(s) of state that matter) is communicated back to the requestor via headers, status, and response body. In REST, the client should include all information for the server to fulfill the request.

Well managed caching serves to facilitate client-server interactions, further improving scalability and performance. Since computers and servers are not concerned with the user interface or user state, computer and servers can be simple and scalable. Computers and servers may be replaced and/or developed independently and the RestAPI interface is maintained unaffected.

A user cannot ordinarily determine whether it is connected directly to the computer or server, or to an intermediary computer. Intermediary computers or servers may improve system scalability by enabling load-balancing and by providing shared caches. And RestAPI protocol layers may enforce security policies and provide redundant data storage.

Once a user sets up a service, an activation application delivers a first display to the user on either a display means of the cell or smart phone, computer or similar apparatus 400, smart internet TVs, smart central hub listening and speaker devices, and home control systems, on the water meter and leak detection system 10 (126 shown in FIGS. 6 and 200 shown in FIG. 7) and/or on a display means on the remote devices 480. Pairing technology or other application secure means associates a new user with a purchased or installed remote device and the water meter and leak detection system 10 (126 shown in FIGS. 6 and 200 shown in FIG. 7). For example, when the new user activates the APP the first screen will request the SSID and password of the local LAN or wireless router and then records this for subsequent access or alternately, scan a QR code with the cell phone. A computer program or web portal can use the internet to allow access for new user's water use and leak detection data by imputing a username and password or using a two-step or three-step authentication scheme.

There are many transfer protocols that may be used to communicate, and transfer water use and water quality data or information with the water meter and leak detection apparatus 10 (126 shown in FIGS. 6 and 200 shown in FIG. 7). This list includes XML technology, Direct Internet Message Encapsulation (“DIME”), Simple Object Access Protocol (SOAP) a HTTP data message to an unsolicited HTTP request, a Rest-API protocol, Java API, DOM API, SAX API, StAX API, and XML API and other application programming interface protocols that provides a control system architecture and/or protocol where a response can be incorporated into another protocol or format.

The water meter and leak detection apparatus 10 (126 shown in FIGS. 6 and 200 shown in FIG. 7) will require the transfer of water use and water quality data or leak detection information using security measures due to violation of municipal or governmental laws and ordinances, and for obstructing fraudulent activities.

There are several important security techniques that taken as a whole, or in part, function to meet the objectives to, including authentication, integrity, encryption, and non-repudiation that provide secure communications.

Two of the best-known uses of public key cryptography are the Public Key Encryption (PKE) and the Digital Signature protocols. PKE is a message or command signal that is encrypted with a recipient's public key. The message cannot be decrypted by any individual or machine that does not possess the matching private key. PKE is a security protocol that is used to maintain confidentiality. Similarly, Digital Signatures are messages or control signals that are signed with the sender's private key and that can be verified by any individual or machine that has access to the sender's public key. This verification proves that the sender had access to the private key, and therefore is likely to be the proper individual or machine to gain access to the message or command signal. Usually a one-way hash is utilized, which is defined as small portion or section of data that can identify and be associated a large volume of data or information that also provided authentication and integrity security measures. Hash functions are known to be resistant to reverse engineering (Secure Hash Algorithm). The Digital Signature protocol also ensures that the message or command signal has not been tampered with, as the original Digital Signature is mathematically bound to the message and verification will fail for practically any other message or command signal. Both PKE and Digital Signatures protocols can be used with the water meter and leak detection apparatus 10 (126 shown in FIGS. 6 and 200 shown in FIG. 7). The strategy of PKE is that each user has a pair of keys; first, a public encryption key, and second, a private decryption key.

Various encryption algorithms include the original RSA algorithm, Advanced Encryption Standard (AES), Data Encryption Standard (DES) and Triple DES.

Secure technologies include the Secure Sockets Layer (“SSL”) which creates a secure connection between two communicating programs or applications. SSL is a standard security technology for establishing an encrypted link between a server and a client; typically, a web server and a mail server or a mail client (e.g., Gmail). SSL uses encryption algorithms to scramble data while in transit, preventing hackers from reading it as it is sent over the internet or other connection. The SSL protocol are commonly utilized by web browsers and web servers in conjunction with HTTP protocol to perform cryptographically secure web transactions. Transport Layer Security (TLS) is an example of an updated, and more secure, version of SSL. A web resource retrievable with HTTP over SSL is usually represented by the protocol identifier “https” in the URL. Secure HTTP (S-HTTP) provides independently applicable security services for transactions using confidentiality, authenticity, and integrity technology.

Another security technology is the Internet Protocol Security (“IPSec”) which protects internet protocol traffic across the Internet and is particularly useful for implementing VPNs that utilized tunnel and encryption techniques. IPSec originally utilized an IP authentication header. IP encapsulating security payload was an optional packed header that can provide superior confidentiality through encryption of the packet. Point-to-Point Tunneling Protocol (“PPTP”) is another secure protocol that allows entities to extend their local network through private “tunnels” over the Internet. Layer Two Tunneling Protocol (“L2TP) is an extension of the PPTP protocol.

A Media Access Control Address (“MAC Address”) is a unique number assigned to a network interface controller for communications with the data link layer of the Open Systems Interconnection Model (OSI Model.) The MAC address is appended to a digital message and provides authentication and integrity for the message.

A further security protocol, the extensible Markup Language (XML) Signature associates a cryptographic signature value with Web resources using XML markup. XML signature also provides for the signing of XML data. Javascript object notation (JSON) has become more popular alternative to XML for various reasons, for example, JSON is less verbose than XML which uses more words that are necessary and JSON is faster parsing whereas XML software is generally slow and cumbersome.

The water meter and leak detection system 10 (126 shown in FIGS. 6 and 200 shown in FIG. 7) should communicate securely with remote displays/recorders 52, 54 or cell phone, smart phone, or similar apparatus 400 and therefore they need to be provided with unique identities. The identity must not be easy to detect either intentionally or accidentally.

Residential and corporate location identity are particularly relevant in multi-site scenarios, where the water meter and leak detection apparatus 10 (126 shown in FIGS. 6 and 200 shown in FIG. 7) are aggregated across a wide geographic area containing multiple sites, serviced by multiple utilities, each site operating on one or more municipal agencies. Each water meter and leak detection apparatus 10 (126 shown in FIGS. 6 and 200 shown in FIG. 7) will need to identify itself when transmitting water use or water quality data or information, or queried by a civil, commercial, municipal or governmental operator or agency.

Each the water meter and leak system apparatus 10 (126 shown in FIGS. 6 and 200 shown in FIG. 7) will have its own identification means that will be recorded in a remote database. The identification can be the Media Access Control (MAC) address (OSI data layer), internet TCP/IP address (OSI transport and network layers), private or public property (ies) building address or users email address or incorporate a distinctive set of numbers or characters associated with a particular municipality or governmental agency.

It is essential that water meter and leak detection systems 10 (126 shown in FIGS. 6 and 200 shown in FIG. 7) will have the same identity within a specific geographical area. It might also be preferred that the entity, municipality or authority name become a portion of the unique identification code. During the fabrication process, the unique identification code could include adding a unique municipality or authority name code in the water meter and leak system apparatus 10 (126 shown in FIGS. 6 and 200 shown in FIG. 7) or software downloaded upon installation or inserted during a repair or maintenance periods.

Public Key Infrastructure (PKI) can also be used in sensor/device to remote receiver situations where encryption and authentication techniques are required. However, many companies and governmental agencies replacing PKI with a two-step authentication procedure using recorded personal information including alternate email addresses and telephone numbers.

A unique identification code registry is maintained within a remote database that is associated with the installation and operation of water meter and leak detection system 10 (126 shown in FIGS. 6 and 200 shown in FIG. 7). The unique identification code registry may be updated whenever a water meter and leak detection system 10 (126 shown in FIGS. 6 and 200 shown in FIG. 7) is brought into or removed from service. The unique identification code registry may be incorporated into the relevant remote database with a unique host name (municipality or governmental agency) or installation region encoded within unique identification code. This would result in several databases that are unique to a given municipality, governmental agency or geographic region. Alternatively, the unique identification registry can be implemented as a single large database. The registry can be implemented as a relational database (e.g., MySQL, MariaSQL), non-relational database (e.g., Amazon DynamoDB), XML files, Comma Separated Value (CSV) Excel files, or Resource Description Files (RDF), or any mechanism that allows associated verification when combined with the appropriate software analysis. The unique identification registry enforces distinctiveness, thereby preventing two water meter and leak detection system 10 (126 shown in FIGS. 6 and 200 shown in FIG. 7 7) from having the same unique identification code.

Encryption, authentication, integrity, and non-repudiation may be important characteristics when the water meter and leak detection system 10 (126 shown in FIGS. 6 and 200 shown in FIG. 7) is transferring water use or water quality data or information to a remote server/database via a public or private network that provide wireless subsequent access to registered computers and cell, smart and mobile phones 400. When water meter and leak detection system 10 (126 shown in FIGS. 6 and 200 shown in FIG. 7) receives or uploads data and information such as a control command signal to send or transmit data and information it is critical that the device can authenticate the sender and be sure of the integrity of the data and information. Encryption provides privacy by converting the data or information into an “encrypted” code to prevent unauthorized access. Encryption can be provided point-to-point, or end-to-end, and transmit messages using encryption schemes such as Pretty Good Privacy (PGP), Secure/Multipurpose Internet Email (S/MIME), XML, or SSL encryption protocols. The wireless communication technologies can utilize encryption technology to inhibit snooping or eavesdropping or prevent unauthorized access when transmitting at least one of the water flow use data, the water energy use data, the water quality data, leak detection, the one or more water flow rate uses, the one or more water use durations, and the one or more total water volumes that is downloaded over a private or corporate network or utilizing a router or access point through the internet from a remote computer operation center or from the cloud service company or to the web-based company. Also at least one of the smart cell phone, mobile phone, PDA, tablet, remote computer, web portal, smart or internet capable television, wireless smartwatch and other electronic communication apparatuses can communicate with one or more wireless communication technologies and utilize encryption technology to inhibit snooping or eavesdropping when transmitting signals or commands to said base station. Non-repudiation prevents the sender from denying that they sent or received data/information or a message. Non-repudiation can be provided by signing, electronic witnessing and technologies that assert a document was read before it was signed.

A newer form of encryption is known as zero-knowledge encryption. In zero-knowledge encryption, a recipient's data is always secured because the decryption key lies with only the intended recipient. The service provider knows nothing about your encryption key and the data you are processing. In the event of a server attack on your service provider, hackers will get nothing except gibberish text because you hold the encryption key. The objective of zero-knowledge encryption is simple, only one intended party can access encrypted data.

Block chain is a collection of data records that is recorded into a decentralized digital ledger. The digital data is organized into pieces that are sequentially arranged and encrypted. A block chain is a trustworthy chain of blocks, each of which contains a list of previously validated transactions. The block chain network functions as a decentralized database since it is maintained by a number of computers that can be located all over the world. This means that each participant or node maintains a copy of the blockchain data and interacts with one another. Block chain transactions utilize a peer-to-peer global network as block chain is not under the control of a single entity. Mining, which is based on the hashing algorithms, is an essential component of almost every block chain. Bitcoin employs the SHA-256 algorithm (Secure hash algorithm 256 bits). In this example, the final output is generally known as a “hash,” and it is consisting of 64 characters (256 bits). After determining that the transaction is authentic, miners encode the transaction into a block (sometimes with many other transactions) and attempt to mine the block. This is performed by running the SHA-256 algorithm on the block. Miners try random nonces until they achieve a correct output hash since a little change in the input substantially impacts the result. The miner publishes the block to all other miners after it has been mined. They then confirm the authenticity of the block before adding it to their copy of the block chain, and the transaction is complete. However, miners must also include the preceding block's output hash in the block so that all blocks are associated, thus the word “blockchain”. Blockchain technology is becoming more commonplace in the financial industry, But blockchain technology can be used for many types of data, such as water flow event data. One of the main advantages of the blockchain technology is that non-repudiation is nearly immutable. Blockchain technology can be used to transfer the water flow data utilizing a blockchain format to one or more remote computers or servers, to a cloud service company or a web-based company. Here, the water meter and leak detection system 10 (126 shown in FIGS. 6 and 200 shown in FIG. 7) can include digital signature technology, data packets or messages using PGP, S/MIME, XML Signature or TLS/SSL to provide for non-repudiation of those messages, information or data.

The water meter and leak detection system 10 (126 shown in FIGS. 6 and 200 shown in FIG. 7) will transfer data to remote computers or servers whereby a user can obtain water use data, water energy data, or water quality information on a predetermined or programmed frequency. The preferred method of water flow sampling rate and data transfer will be on a water flow event basis which monitors the initiation of water use, its initial water flow rate, intermediate water flow rates, and when the water ceases to flow (turned off) the water use duration and total water used is calculated. The frequency or water sampling rate can be programmed for various periods, e.g., once every 1-30 seconds (for monitoring the water flow event), once per minute, once or twice per hour, once per day, once per week, once per month or once per year or can be transfer to a remote computer/server and accessed by a cell phone, smart phones, mobile phone, computer, or other mobile electronic communication device. Also, when the data or information can be processed by an automated system and reports are only created every day, or week, or month, there is some flexibility when the data must be sent. The water meter and leak detection system 10 (126 shown in FIGS. 6 and 200 shown in FIG. 7) can be programmed to automatically have a sampling rate (after a sleep mode) and communicate at every 1-30 seconds or other time frequencies, such as every 5 seconds or every minute, for various purposes, for example, to identify leaking conditions. In this case, data transfer and signature calculations can be executed only when there is free processing time. This scheme performs well with the water meter and leak detection system 10 (126 shown in FIGS. 6 and 200 shown in FIG. 7) where important real-time calculations can take up significant available calculation time for small periods, but over time periods of a few hours, when water is not flowing, there is processing time to spare.

In an alternate embodiment, the encrypted data is transmitted optionally to a local router/server and then across the Internet or cell tower technology, or via directly to a public or private network as it has been described herein. This is accomplished directly by the water meter collection node or by using remote receiving stations or communication hub 477 with Wi-Fi, Wi-Fi versions 3/4/5/6, Wi-Fi7, Li-Fi or LoRa, Sigfox, WiMAX, Ultra Narrow Band (UNB), NB-IoT, M-Bus, 6LOWPAN, standard Wi-Fi, Wi-Fi versions 3/4/5/6 with Wi-Fi extenders) and Amazon Sidewalk technology 103 wireless or wired directly to the internet router that communicates to remote servers. In the LoRa, Sigfox WiMAX (or Ultra Narrow Band (UNB), NB-IoT, 6LOWPAN, M-Bus, standard Wi-Fi, Wi-Fi versions 3/4/5/6 with Wi-Fi extenders) and Amazon Sidewalk technology 103 wireless communications, the current marketed routers would have to be modified to receive the LoRa, WiMAX, M-Bus, (UNB, 6LoWPAN) wireless half or full duplex transmission. This has the advantage that water meter and leak detection system 10 (126 shown in FIGS. 6 and 200 shown in FIG. 7) does not need to store, but can, encrypted data.

The water meter and leak detection system 10 (126 shown in FIGS. 6 and 200 shown in FIG. 7) can include a removable or a non-removable storage device that can contain use and/or water quality data. This removable storage device may be removed when there is a disruption in wireless transmittal of data, to upgrade configuration programs, or to download stored data for subsequent analysis. The water meter and leak detection system 10, (126 shown in FIGS. 6 and 200 shown in FIG. 7) may be fitted with a physical lock that prevents unauthorized individuals from detaching the removable storage device.

Software may be designed to validate digital signatures before water use or water quality data or information can be downloaded or allow registered users to upload updated software and/or firmware. The water use data updated software and/or firmware may incorporate its own code (e.g., RestAPI) to verify digital signatures to ensure that the original software and/or firmware has not been tampered with and is from an authorized source. The uploaded firmware or software can be written in various languages, to name a few, such as Java, Javascript, NodeJS, Prolog, Haskell, binary executable code, C+ and C++, and ECMA Common Language Runtime (“ECMA CLR”). In additional, the water meter and leak detection system 10 (126 shown in FIGS. 6 and 200 shown in FIG. 7) or the remote display means 18, 50, 56, or computer, cell, smart or mobile phone 400 could include a microprocessor that has a data memory bank with data memory that stores the water use data that can be compared with the data that has been transferred and uploaded by the government or municipal second remote display/recorded means 56.

In addition, any stored data, including cached data and data stored in a database, is identified with a digital signature. When the data is retrieved, the digital signature can be used to verify that the data has not been tampered or changed.

Referring now to the drawings and particularly to FIG. 2 is a perspective view of the first embodiment comprising an optional primary or secondary water meter and leak detection system 10 (126 shown in FIGS. 6 and 200 shown in FIG. 7) attached to the cold and hot input water supply piping 14 and water supply piping. The plurality of water pipe unions or joints 30, 32, 34 and 36 can be fabricated from typical metallic or polymeric materials.

Also shown in FIG. 2, one or more optionally and ergonomically 19, 21, and/or 23 placed buttons or activators can be incorporated into the display housing to allow the modification of certain parameter units (e.g., metric to US), set alarm conditions (e.g., flow/volume rate-set points), or to program certain settings, e.g., over water use alarm, monitor continuous leakage (valve not complete shut off

A visual alarm or signal can be incorporated into the present invention whereby a preset alarm or programmed alarm, changes the one or more of the screen displays, for example, blinking a parameter, or changing the color of a parameter (green to red).

An optional visual alarm might include visual reference on the water meter or on a cell phone, for example, an in-operative condition, broken sensor, low power source, no flow, reverse flow, and/or some default limits. Programmed visual alarms would allow for individual selection (e.g., volume over set point, flow rate set point, total volume exceeded set points) which might be restricted or not by the default settings.

In addition, an auditory alarm can be incorporated into the present invention whereby a preset alarm or programmed alarm, changes the screen display, for example, using sound or pulsing a specific noise, or changing the color of a parameter. For example, the temperature or pressure display can change from green to red when a preset temperature or pressure is beyond a specific or programmed limit. A preset alarm might include visual reference, for example, an in-operative condition, broken sensor, low power source and some default limits. Programmed auditory alarms would allow for individual selection (e.g., water use over set point, time past set point, flow rate set points) which might be restricted or not by the default settings.

In addition, the water meter and leak detection system 10 (126 shown in FIGS. 6 and 200 shown in FIG. 7) can include water control valve mechanism or shut off means to turn off the water supply if an alarm condition or setting point is exceeded and has been activated. The water control valve mechanism can also be programmed or used to turn the water supply on and off during a work or vacation schedule. The water control valve mechanism or shut off means is electrically connected to the CPU or microprocessor and has an electrical power to move a ball valve position or energize a solenoid valve, such the computer controls the application of electrical power to activate or de-activate the water shut off means. The water shut off means can comprise, for example, a typical electronically controlled ball valve or solenoid shut off valve incorporated into, or in series with, the water meter collection node such that water from the source is closed. The electronically controlled ball or solenoid valve can also be incorporated into the water meter collection node as an integrated unit. The water control valve mechanism or shut off means can be activated if an alarm state has been achieved, e.g., 200 gals/day of water is exceeded the total of e.g., 50 gallons of water has flowed in an unusual duration or flow rate since the water source was opened. The alarm or settings can be a default setting installed by the manufacturer or programmed by the user. In addition, the water meter and leak detection system can have capabilities such as vacation mode that turns off the water on a specific date and then turns the water on for the returning date. A scheduling mode can also be programmed that turns off the water when the home is unoccupied, e.g., when the family is at work from 8 a.m. to 5 p.m. In addition, the scheduling can be coupled with the vacation mode to allow the water to be turn on only for the date and times the irrigation is desired to be operational. The water control valve can have a variable open design whereby different opening of e.g., ball valve, electrical activation or de-activation can change the opening and resulting flow rates. The water control valve mechanism can be a three-way design that functions to control the turning on or off the water supply and using the third port to drain water from the home or corporation if freezing conditions are observed.

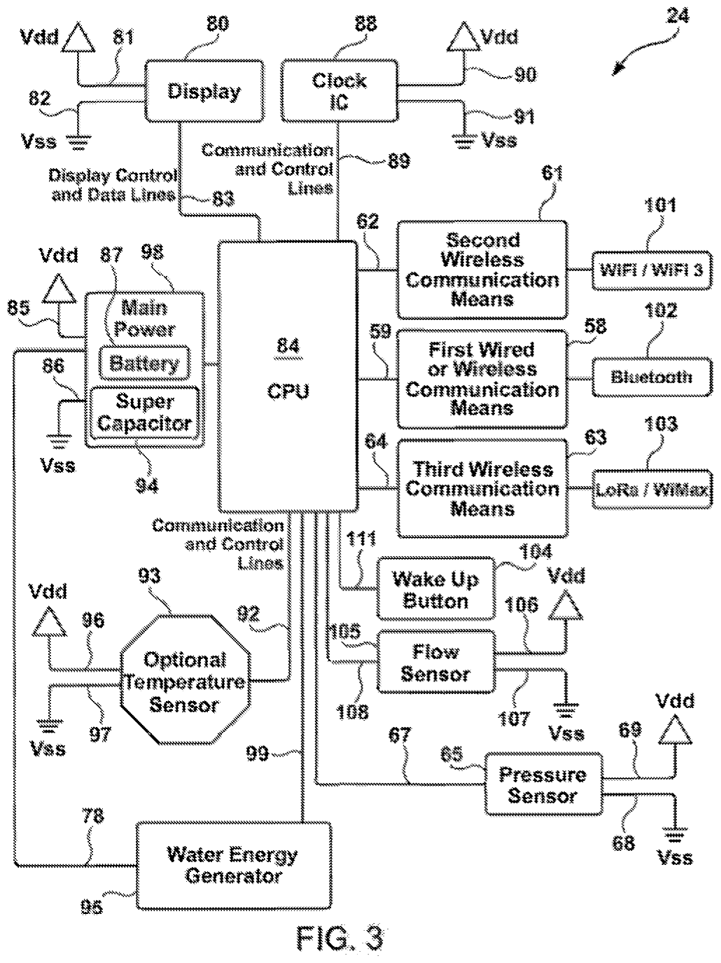

Now referring to FIG. 3, shown is a is a timing clock integrated circuit 88 with data transfer means 89 for communicating with the CPU or microprocessor, or microcontroller 84 and having a power line 85 and ground line 86. The timing circuit 88 can communicate with the CPU, microprocessor, or microcontroller 84 to an optional display 80 such information such as the time of day and current date and/or a time stamp for the duration that the water supply has turned been on and off. For monitoring the time stamp parameters of the water flowing through the present invention, the use of various trip switches or water sensors in close proximity to the flowing water can be monitored. The timing clock IC 88 will assist by communicating a signal to the CPU or microprocessor 84 that the water supply has been turn on and then shut off such that the software instructions and CPU or microprocessor can calculate various parameters, such as, but not limited to, the duration of water supply, total number of gallons or liters of water used and flow rates.

An optional temperature sensor and associated temperature integrated circuit 93 with a data transfer means 92 for communicating with the CPU, microprocessor and/or microcontroller 84 and having a power line 96 and ground 97. Also shown is one or more flow sensors 105 (e.g., flow rate, pressure, ultrasonic, turbine, acoustic with a data transfer means 108 for communicating with the CPU, microprocessor and/or microcontroller 84 a power line 106 and ground line 107. The integrated circuits for the timing clock 88, temperature sensor 93 and flow sensor 105 can include circuitry to convert analog data to a digital format. Also shown is a first wireless electronic communication radio or means 58 consisting of Bluetooth, Bluetooth low energy (BLE), Z-wave and Zigbee and other similar short-range wireless technology 102 with a data transfer 104. A second wireless electronic communication radio or means 61 with a data transfer 62 consisting of Wi-Fi, Wi-Fi versions 3/4/5/6, Wi-Fi7, Li-Fi, and other similar wireless technology where data transfer means 62 communicates with the CPU 84. A third wireless electronic communication means 63 with a data transfer means 64 consisting of LoRa, Sigfox, WiMAX, Ultra Narrow Band (UMB), NB-IoT, M-Bus, Amazon Sidewalk Technology, 6LoWPAN and other long-range wireless technology where data transfer 64 communicates with the CPU 84. The third wireless communication can also include cellular technology (46 as shown in FIG. 1) that is designed to communicate data utilizing a cellular format (standard 2G, 3GPP or LTE-M, 4G and 5G cellular) with connection to offsite central monitoring computer using cell towers and other telephone lines via satellite, microwave technology, and the internet. Such cellular format could be CDMA, GSM, or another advanced cellular formats (3GPP/LTE-M, 4G and 5G).

Also shown in FIG. 3 is an optional display 80 with a power line 81 and ground line 82. The display can utilize LCD, LED, gas plasma, fluorescence, incandescent, halogen, halide, or other lighting technologies.

An optional water energy generator 95 with data transfer communication 99 for communicating with the CPU (microprocessor and/or microcontroller) 84 with a power line 78 to the main power supply 98. The water energy generator 95 can be a turbine, paddle, Pelton type or other similar technology. Recharging batteries 87 or super capacitors 94 can be accessed from a waterproof door of the collection node housing or with a water-proof electrical coupler on the housing where the one or more batteries reside outside of the housing for periodic maintenance.

Also shown is an optional pressure sensor 65 with date transfer communication 67 and a power line 69 and ground line 68. Pressure sensors are valuable in detecting small changes in water pressure for determining valve opening and closing, quick decay curves and are particularly advantageous for detecting small leaks when the water valve mechanism is closed and pressure changes are monitored.

Main power 98 produces a power line 85 and a ground line 86. The main power 98 is preferably one or more batteries 87 and/or on or more super capacitors 94 as the power source. With the one or more batteries or super capacitors, is would be possible to have the water energy generator 95 to supplant energy when generated during periods that water flow occurs. An example of long-life batteries that can be used with the water meter with leak detection system 10, 126, 200 are the industrial lithium thionyl chloride (LiSOCl₂)) bobbin-type or spiral wound batteries produced by companies such as Tadiran Battery company. Super capacitors store energy by means of a static charge caused by a voltage differential on position and negative plates. Super capacitors should have a high capacitance which is ideal for applications that require frequent charging and discharging at high current and a short duration. A super capacitor can also operate like a battery with the addition of special electrodes and electrolytes to increase its energy density. Higher voltage can be produced, but the trade-off is shorter service life. To obtain higher voltage, super capacitors must be connected in series. When two or more super capacitors are connected in series, protective circuitry is required to prevent any cell from going over-voltage. The self-discharge rate of a super capacitor can be much higher than a Li-ion battery, as certain super capacitors can discharge 50% to 100% of their available capacity in 30 to 40 days. A LiSOCl₂ bobbin type battery with a hybrid super capacitor would be an ideal primary cell power source that offers the highest capacity and highest energy density of any sole lithium cell, along with an extremely low annual self-discharge rate.

It is anticipated that solar panels (water meter box cover) or wind generator can be also used to supplant electrical energy. It is also anticipated that AC or DC (AC-DC adapter) can be used for electrical energy.

The CPU, microprocessor or microcontroller 84 that processes the information supplied by the flow sensor 105, the optional temperature sensor 93, the optional pressure sensor 65, and timing circuit 88 uses internal instructions to control the information projected on a display, transferring water use data by wired or wireless communication, and for processing leak detection alarm states. The microprocessor can include an EPROM or any type of memory section that allows for specific programming to be incorporated as processing instructions. Furthermore, the microprocessor may have the capability to convert analog signals into digital information for decoding and processing.

In addition, a means to record and digitally store the water parameters or data can be incorporated into the present invention. An integrated memory circuit can be incorporated into the CPU or microprocessor 84, or can be a separate memory circuit, and can include associated circuitry with a means to transfer the recorded data to a removable media, such as a flash mount on an electronic circuit board to control the display means and communicate with the sensors.

Because the water meter and leak detection system can be used in situations where the source of water comes for a well or non-commercial operation, and furthermore, where the commercial operations water treatments plants are under pressure to provide more water supplies or where problems, breakdowns or accidental situations can cause contamination of the water source, the present invention can be fitted with, display parameters of, and provide warning for, numerous mineral, elements and biological contaminates.

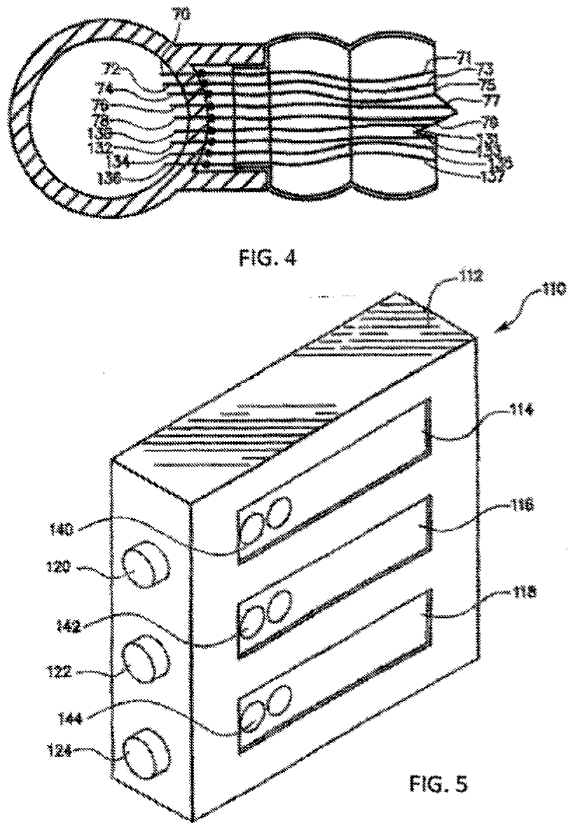

As illustrated in FIG. 4 is a cross-section showing the one or more sensors 70, 72, 74, 76, 78, 130, 132, 134, and 136 located in close proximity to water supply line 20, 22 and/or a water delivery supply line 24, 26 and their relative position of the sensors in the supply line lumen 38 and the connecting wires 71, 73, 75, 77, 79, 131, 133, 135 and 137 for the display means, data transfer etc. For exemplary purposes, sensor 72 could be a timing sensor e.g., to monitor when water is flowing, sensor 74 can be a temperature sensor, sensor 76 can be a flow sensor, 78 can be a halogen (e.g., chloride or fluoride) sensor, 130 can be a total dissolved solids sensor, 132 can be a biological or fecal sensor, and 134 can be a water hardness sensor and 136 can be a specific iron or other mineral sensor.

There are many types of sensors that can be used with the present invention. Since a significant small change involves an exchange of energy, sensors can be classified according to the type of energy transfer that they detect. For measuring or monitoring the temperature of the water flowing from the shower or bath head, the use of various thermocouples or thermistor sensors 70 as depicted in FIG. 3 is protruding within the water supply lumen 38 (or in close proximity to the water to be measured) and mounted within the articulating joint mechanism 22. Wires 71 are shown extending from the sensor 70 to electronically communicate with the CPU or microprocessor 84 and display unit.

Thermocouples measure the temperature difference between two points, not absolute temperature. In traditional applications, one of the junctions, the cold junction, was maintained at a known (reference) temperature, while the other end was attached to a probe.

A thermistor is a type of resistor used to measure temperature changes, relying on the change in its resistance with changing temperature. Thermistors can be classified into two types depending on the sign of k. If k is positive, the resistance increases with increasing temperature. If is negative, the resistance decreases with in decreasing temperature, and the device is called a negative temperature coefficient (NTC) thermistor.

It is anticipated by the Applicant that various types of thermocouples or thermistors can be used for the present invention. It is not important what type of thermocouple or thermistor is utilized for monitoring the water supply lines except that it is accurate for the appropriate temperature range monitored or measured.

To monitor or measure the flow rate of the water being delivered by the water supply line various flow measuring technologies are applicable to the present invention water meter.

The flow sensor 105 can utilize pressure sensor technology. Pressure sensors can be particularly useful in monitor the water valve opening and closing, or measuring small leaks by and shutting of the water supply line and then monitoring the pressure loss over time.

There is also a category of pressure sensors that are designed to measure in a dynamic mode for capturing very high-speed changes in pressure. These sensors are commonly manufactured out of piezoelectric materials like quartz. Pressure sensors can perform as a flow rate sensor (e.g., the differential pressure gauges Motorola MPX5700) or be sensitive types that can sense pressure waves and pressure changes for water pattern analysis. One particular use would be to use the pressure sensor (e.g., ceramic capacitive pressure sensor) to monitor the pressure of a private or public property after a water control valve has turned off the water supply. The pressure sensor can then measure the decay in pressure reads to observe and indicate small leaks (dripping faucet).

Acoustic sensors are advancing to the point where they can monitor water flow and pressure readings that are approaching actual quantifiable results. Acoustic sensor original function is to listen and record water valve noises and vibration frequencies. It is anticipated that all water devices have a valve with a unique “open” and “close” noise and vibration frequency. An acoustic sensor can therefore be significantly useful for identifying various water devices such as showers, washing machines, toilets, irrigation valves, bathroom, and kitchen faucets, etc. and other water fixtures and appliances. As each of the water use devices is used, the acoustic sensor can specifically identify the particular water use device. It is also useful in apartment or condo situations where this is only a single water meter all apartments or condos. The acoustic sensor will be able to characterize all the various water use fixtures, appliances, and devices contain within these apartments and condos. The acoustic sensor can also be used to detect water leaks as water leaks make noises like water valves opening and closing. But water leaks (e.g., toilet flapper valves, dripping faucets tend to have more continual noise patterns that can last for longer periods. The acoustic sensor identifies use water valve movements and noises when being opened or close, or observing vibrational frequencies when water is flowing past the water valve (e.g., toilet flapper valve). To supplement the acoustic sensor, various noise making orifices or vibration devices can be installed at various place for identification by the acoustic sensor. With artificial intelligence (AI) and other programming software, the acoustic sensor can now monitor water flow characteristics. Like a flow rate sensor, the acoustic sensor with programming software can also monitor, or add information to augment, the flow rate, the duration, and the total water volume to determine water signatures and patterns of water fixtures and appliances.

In addition, various flow measuring technologies can be utilized as the flow sensor 105. In general, a flow sensor is a device for sensing the rate of fluid flow. Typically, a flow sensor is the sensing element used in a flow meter, or flow logger, to record the flow of fluids. There are various kinds of flow meters, including some that have a vane that is pushed by the fluid, or similar device. Flow meters are related to devices called velocimeters that measure velocity of fluids flowing through them. Another approach is Doppler-based methods for flow measurement. Hall effect sensors may also be used, on a flapper valve, or vane, to sense the position of the vane, as displaced by fluid flow. Alternatively, pressure sensors can be placed at each node, and the fluid network can be solved by knowing the pressure at every node. Flow meters generally cost more than pressure sensors, so it is often more economical to solve a fluid dynamics network monitoring problem by way of pressure sensors than to use flow meters.

Somewhat older and proven technology, such as Positive Displacement Meter (“PD”) meters measure water volume with an oscillating piston or a nutating disc is still be used in water meters today. The disc or piston has very high tolerances between it and the water meter chamber. Water must push or “displace” the measuring element disc or piston to be able to go through the meter. Because of high tolerances, new and well maintained, PD meters can be very accurate. One disadvantage is that PD meters can have more pressure loss and be somewhat noisier in indoor locations at high flow rates than ultrasonic (see below) or multi-jet meters. Also, as PD meters wear out, they cannot be recalibrated but must be completely rebuilt with new chamber or just replaced with a new meter. Because water cannot pass through the meter without moving the measuring element, they are good candidates for incorporating a stop mechanism such as a solenoid activated mechanism or pin (not shown) that impedes the oscillating piston or nutating disc from operating and restricts the flow of water. Such activated mechanisms can be wirelessly (or wired) controlled remotely as described herein.

The paddle wheel translates the mechanical action of paddles rotating in the liquid flow around an axis into a user-readable rate of flow (GPM, LPM, etc.). The paddle tends must be at least partially inserted into the water flow. The Pelton wheel turbine (better described as a radial turbine) translates the mechanical action of the Pelton wheel rotating in the liquid flow around an axis into a user-readable rate of flow (GPM, LPM, etc.). The Pelton wheel tends to have the water flow travelling around it. The turbine flowmeter (better described as an axial turbine) translates the mechanical action of the turbine rotating in the liquid flow around an axis into a user-readable rate of flow (GMP, LPM, etc.).

It is anticipated by the Applicant that the paddle wheel, Pelton wheel and/or turbine flow meter can be modified to also be used to generate electrical energy using typical wire and magnets technology. And it is anticipated by the Applicant the paddle wheel, Pelton wheel and/or turbine flow meter can generate electrical energy and perform as a flow meter simultaneously. As electrical energy is generated, back EMF becomes a factor and reduces the rotational speed. Intelligent software must be employed to compensate for the paddle wheel, Pelton wheel or turbine flow meter slowing its rotation when generating electrical energy. The calibration for the amount of energy generated versus the loss in rotation speed for a measured flow of water can be calculated appropriately. Alternately, the intelligent software can switch energy generation off and on over a period of time and only monitor water flow rate when the energy generation is switched off.

In addition, various magnetic, ultrasound and Coriolis flow meters can be utilized with the present invention to function as the flow sensor 105. Modern innovations in the measurement of flow rate incorporate electronic devices that can correct for varying pressure and temperature (i.e., density) conditions, non-linearities, and for the characteristics of the fluid. The most common flow meter apart from the mechanical flow meters, is the magnetic flow meter. A magnetic field is applied to the metering tube, which results in a potential difference proportional to the flow velocity perpendicular to the flux lines. The physical principle at work is Faraday's law of electromagnetic induction. The magnetic flow meter requires a conducting fluid, e.g., water, and an electrical insulating pipe surface, e.g., a rubber lined non-magnetic steel or polymeric tube.

Ultrasonic flow meters are becoming more prevalent in water meters and measure the difference of the transit time of ultrasonic pulses propagating in and against flow direction. This time difference is a measure for the average velocity of the fluid along the path of the ultrasonic beam. By using the absolute transit times both the averaged fluid velocity and the speed of sound can be calculated. There are most common two types of ultrasonic flowmeter technology, Doppler frequency shift ultrasonic flowmeter and transit time ultrasonic flowmeter.

Measurement of the Doppler shift resulting in reflecting an ultrasonic beam off the flowing fluid is another recent innovation made possible by electronics. By passing an ultrasonic beam through the water pipe, bouncing it off a reflective plate then reversing the direction of the beam and repeating the measurement the volume of water flow can be estimated. The speed of transmission is affected by the movement of water in the supply pipe and by comparing the time taken to complete the cycle upstream versus downstream the flow of water through the supply pipe can be measured. The difference between the two speeds is a measure of true volume flow, Measurement of transit time ultrasonic measurement calculates the difference in time from when an ultrasonic signal is transmitted from the first transducer until it crosses the pipe and is received by the second transducer. A comparison is made of upstream and downstream measurements. If there is no flow, the travel time will be the same in both directions. When flow is present, sound moves faster if traveling in the same direction and slower if moving against it.

Multi-jet meters, positive displacement meter (e.g., nutating disc), single jet meters, pressure sensors, magnetic, ultrasound and Coriolis flow meters can be utilized with the present invention to function as the flow sensor 105.

In addition, as shown in FIG. 4, is an optional halogen (chloride or fluoride) sensor 78, Total Dissolved Solids (IDS) sensor 132, optional sensor 136 to measure or monitor the amount of iron and other metallic ions, biological or fecal coliform sensor 132, optional pH sensor and optional water hardness sensor 134.

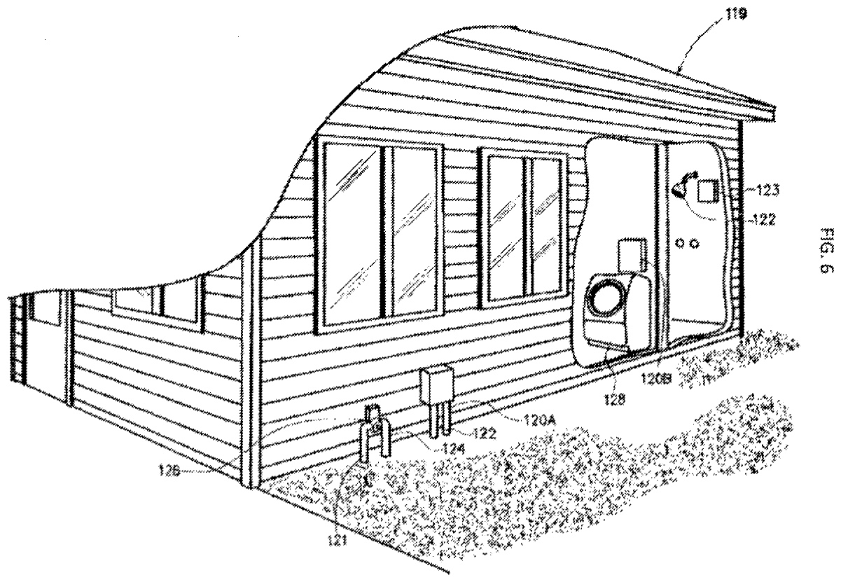

Now referring to FIG. 5, which presents an example 110 of either the custom display/recorder 50 or the second optional (handheld) display/recorder 56. The first display/recorder 50 or optional second (handheld) display/recorder 56 includes a housing or container 112, display means 114, 116, and 118, software control buttons 120, 122, and 124, the electronic circuit board with wire or wireless capability, and power source are common between the two apparatuses, or could utilized is a computer, television or cell phone, smart phone or similar apparatus that has an internet, intranet, wire or wireless connectivity.

Also shown in FIG. 5, one or more ergonomically 120, 122, and/or 124 placed buttons or activators which can be incorporated into the display means housing to allow the modification of certain parameter units (e.g. metric to US), set alarm conditions (e.g. flow/volume rate-set points), or to program certain settings, e.g. over water use alarm, monitor continuous leakage, and/or control valve not complete shut off or completely open.

Now referring to FIG. 6 is a perspective view of a plurality of optional water parameter transceivers attached to water use devices at various locations for monitoring water use and furthermore for monitoring for water leaks. In this example, the typical locations for the leak sensitive water flow sensors are at the water input supply lines 121 for a typical washing machine 128, a sprinkler system 122, and the at the reduction valve 121. The leak sensitive sensors can also be located on water use devices such as showers 122, sinks, toilets, hot water heaters 120b, bathtubs, washing machines, dishwashers and the like.

The water meter and leak detection system 10, 126 (and 200 in FIG. 7) can include a series of water flow sensors or pressure sensors that can be connected to different locations, such as the irrigation system. In this way, the use of indoor water use (data acquired by the installed water meter and leak detection system 10, 126 and 200 shown in FIG. 7) and outdoor water (data acquired by flow or pressure sensor at irrigation system) use can be independently monitored. This can be useful for an individual or commercial operator to employ water conservation methods (e.g., reduce the sprinkler frequency or duration), Alternately, the monitoring of indoor water use, and outdoor water use, could be utilized by the particular water supplying municipality or government agency to apply different rates for indoor water use and outdoor water use. In certain situations, a control valve can be located at a particular location, e.g., the irrigation valve whereby by utilizing the two-way wireless capability of the water meter and leak detection system 10, 126 (and 200 shown in FIG. 7), whereby the water supplying municipality or government agency can remotely control water use (e.g., send out a code that inhibits outdoor water use on certain days or at certain hours of the day).

Coordination of data packet transmissions from the invasive flow sensor, non-invasive flow sensor, pressure sensors and/or sensitive flow sensors with transceivers can be programmed to define a schedule. The water meter and leak detection system 10, 126, (and 200 shown in FIG. 7) can run a master schedule for querying each invasive flow sensor, non-invasive flow sensor and/or highly sensitive flow sensors with transceivers. For example, water meter and leak detection system 10, 126 (and 200 shown in FIG. 7) can transmit a message to a specific collection node and that collection node can then sequentially request data from each of its invasive flow sensor, non-invasive flow sensor, pressure sensor and/or sensitive flow sensors with transceivers. This systematic process can reduce data packet collision on the network and can make the water meter and leak detection system 10, 126 (and 200 shown in FIG. 7) immediately aware of any invasive flow sensor, non-invasive flow sensor and/or sensitive flow sensors with transceivers that might be having trouble transmitting its data packet. The water meter and leak detection system 10, 126 (and 200 shown in FIG. 7) can transmit an acknowledgement to each invasive flow sensor, non-invasive flow sensor and/or highly sensitive flow sensors with transceivers after successfully processing a data packet.

The software in the water meter and leak detection system 10, 126 (and 200 shown in FIG. 7) is designed to perceive water flow characteristics in the facility for a given unit of time, such as, for example, a day, for every unit in the facility. The software should be designed to identify numerous conditions, such as, for example, faulty toilet valves, periodic and irregular water flow for example toilets, faucets, and a slow constant water flow, a characteristic of a leakage condition.

Referring to FIG. 7, the water meter and leak detection system 10, 126, (and 200 in FIG. 7) with water shut-off/on mechanism 310 strategically located between a main supply line 208 from a water main and a household water supply line 210 to a residential building 202. The water meter and leak detection system 10, 126, (and 200 in FIG. 7), with water shut-off/on mechanism can be activated and deactivated by a remote controller 220 to selectively turn on and off the water through the household water supply line 210. In the preferred embodiment of the present invention, the water meter and leak detection system 10, 126, (and 200 in FIG. 7) with water shut-off/on mechanism 310 is located with respect to the household water supply line 208 such that water flow through the household water supply line 210 to the living quarters of the residential building 202 may be prevented while still allowing water flow to non-residential areas, such as to sprinkler lines. It is anticipated by the Applicant that separate water shut-off/on mechanisms 310 can be located on various household water supply line 208 (e.g. toilet, washing machine) and the irrigation water supply lines. The multiple water shut-off/on mechanisms will have electrical circuitry and wireless radios such they can be controlled remotely through communication and commands/signals with the remote server over the internet from a cell phone APP. It is also anticipated by the Applicants that the water meter with leak detection system 10, 126, 200 with water shut-off/on mechanism 310 can take the place of, and function as, the main water meter and/or incorporate a pressure reduction valve. FIG. 1 also shows the water meter and leak detection system 10, 126, 200 with water shut-off/on mechanism 310 connected with a wired means 205 from a solar electrical generation 204 and/or connected with a wired means 207 from a wind electrical generation 206. In this regard, the water meter and leak detection system 10, 126, 200 with shut-off/on mechanism 210 can be battery operated and utilize re-chargeable batteries or super capacitors that can be charged with a water turbine electric generator or have typical batteries that are replaceable. The Water meter and leak detection system 10, 126, (and 200 in FIG. 7) with shut-off/on mechanism 310 can also be AC or DC powered. An antenna 322 is shown extending from the water meter collection node with water shut-off/on mechanism. The shut-off mechanism can be a simple on-off solenoid mechanism, a ball valve type mechanism, or a three-way mechanism that can be useful to draining water from the main water lines when freezing conditions arise.

The housing for the water meter and leak detection system 10, 126, 200 (with water shut-off/on mechanism 310) can be fabricated from a metallic or polymeric material with sealing technology to protect from moisture damage or freezing conditions.

The joint connection between the water supply lines 208 and 210 and the water meter and leak detection system 10, 126, 200 with water shut-off/on mechanism 310 could be screw and thread fitting, compression fitting, flare fitting, solder, brazed, or sweat joint, adhesive technology and/or use typical plumbing techniques. The joint may be designed to be permanent or removable.

The water meter and leak detection system 10, 126, 200 can incorporate a freeze design feature which, before a freezing condition is encountered, activates a freezing mechanism. An optional frost/freeze plug can be incorporated with a draining mechanism or system that allows the water to passively drain from the private or public property water pipes or forcefully removes the water from the water pipes with a power system. And it is anticipated that in these extraordinary freezing situations, the draining mechanism or system can also replace the water in the water pipes with air, nitrogen or other gas/liquid that have low freezing points and non-toxic conditions, can withstand the freezing conditions to minimize damage to the water pipes. Furthermore, be communicating with a home router, the Water meter and leak detection system 10, 126, 200 can communicate with intelligent thermostats sending a signal to turn on the residential or corporation heat to a temperature that will inhibit freezing water in the residential and corporation interior water pipes.

The water meter and leak detection system 10, 126, 200 with water shut-off/on mechanism 310 can include an optional display means 211 for displaying various information, such as if the water is interrupted or allowed to flow into the private or public property facility or building, or to help program the software for scheduled water interruption times (off from 8:30 a.m. until 4:30 p.m. then on, off again at 11:00 p.m. until 5:00 a.m. and then on again). The display means 211 can help program the software to display calendar information, such as the date and current time (12 hr. or 24 hr. format). In this regard, the water meter collection node 200 can be programmed using a wire or wireless remote keyboard, alarm system, or use touch screen button technology on the display.

One of the key features of the water meter and leak detection system is that it has a convenient and easy means which facilitates activation and/or deactivation of the water flow from the main water supply when a private or public property facility or building becomes vacated or unsupervised. In this regard, shown in FIG. 7 is an individual 212 holding a cell phone, smart phones, or similar apparatus 400 for communicating with the water meter and leak detection system 10, 126, 200 can be used to control the water flow.

For leak detection capability is would be preferred that the water meter and leak detection system 10, 126, (and 200 in FIG. 7) with a water shut-off/on mechanism 310 can include programming instructions with a timing circuit to a user defined time schedule. In this manner, the private or public property owner may simply establish that the water supply will be shut off or blocked during non-working hours, during a vacation, and/or during sleeping hours. The scheduling could be a daily, weekly, monthly, or annual or on a water flow use basis. The programming of the timing schedule could be input into the CPU of the water meter collection node electrical circuitry via various methods, e.g. wireless or wired communication with a computer with appropriate software, using the remote controllers, or using touch screen technology on the display means, etc.

Now referring to FIG. 8, shown is a perspective more detailed view of the water meter and leak detection system 10, 126, 200 with water shut-off/on mechanism 310 and water supply plumbing, and with optional water turbine generator 308 that is located within the water supply line. The water supply line from the water main 208 first engages a manual shut off valve 302. The manual shut off valve can be a ball valve, solenoid valve, gate value type, piston valve, or other known technology. Further along the water supply line is a pressure regulator 304 with a connecting pipe 306 to the water meter and leak detection system 10, 126, (and 200 in FIG. 7) with water shut-off/on mechanism 310. Also shown is an optional water turbine generator 308 that could be utilized to produce electrical energy for recharging the battery source 326. The water shut-off/on mechanism 310 (shown as solenoid shutoff valve) can be a ball valve, solenoid valve, gate value type, piston valve, or other known technology with electronic activation. A mechanical lever or electric button/toggle switch 311 can be incorporated on the water shut-off/on mechanism (solenoid shutoff valve) to allow the modification of the mechanism to open the water flow in emergency and necessary situations. The water meter and leak detection system 10, 126, (and 200 in FIG. 7) has a transceiver 320 that includes an antenna 322 which can be external or internal. The control circuit for the water meter and leak detection system 10, 126, (and 200 in FIG. 7) shown in more detail in FIG. 3, includes programmable CPU, a power source using either a battery or super capacitor (rechargeable) 326 or typical AC or DC supply 324, and/or electrical circuitry, wireless or hard-wired components, and optional sensors and associated circuitry. Also shown is a battery voltage 326 which would electronically engage the optional solar cell 302 or wind generator 206 to provide additional electrical energy. It is anticipated by the Applicant's that the water shut-off/on mechanism 311 (ball valve or solenoid shutoff valve), and if used, the optional water turbine generator 308, could be incorporated within the water meter and leak detection system 10, 126, (and 200 in FIG. 7) as a single unit. It is also anticipated that the water meter and leak detection system 10, 126, 200 with water shut-off/on valve 310 could replace, and function as, the pressure regulator, eliminating one of the components shown in this drawing. Exiting from water meter and leak detection system 10, 126, 200 with water shut-off/on mechanism 310 is the main water supply 312 to the home (private or public property. It is also anticipated that water meter and leak detection system 10, 126, 200 with water shut-off/on valve 310 could replace, and function as, the main water meter.

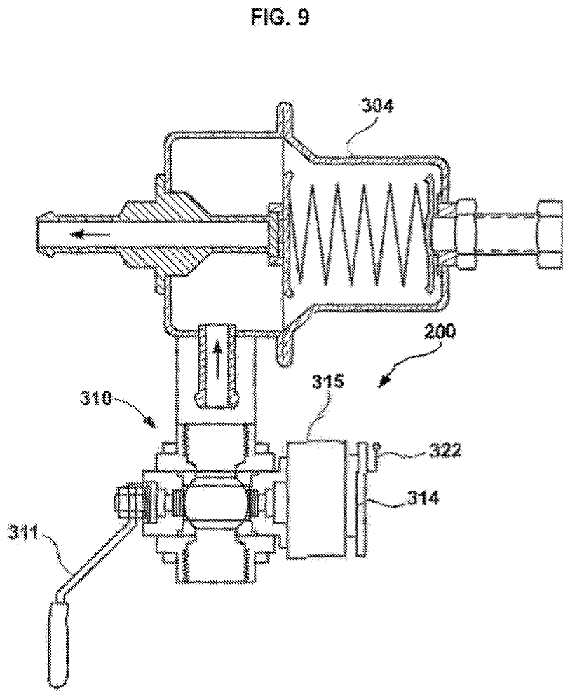

FIG. 9 is another embodiment of the water meter and leak detection system 10, 126, 200 with a perspective detailed view of the water shut-off/on mechanism combined with an independent pressure regulator or reduction valve and functioning as a combined system consisting of a water meter collection node with one or more water flow sensors having a water shut-off/on mechanism and pressure reduction valve. Shown is a typical water pressure reduction valve 304 connected directly with the water meter and leak detection system 10, 126, 200 with water shut-off/on mechanism 200 having a ball valve 310, a manual on-off handle 311, an electric motor 315, electrical circuitry 314 with a wireless antenna 322.

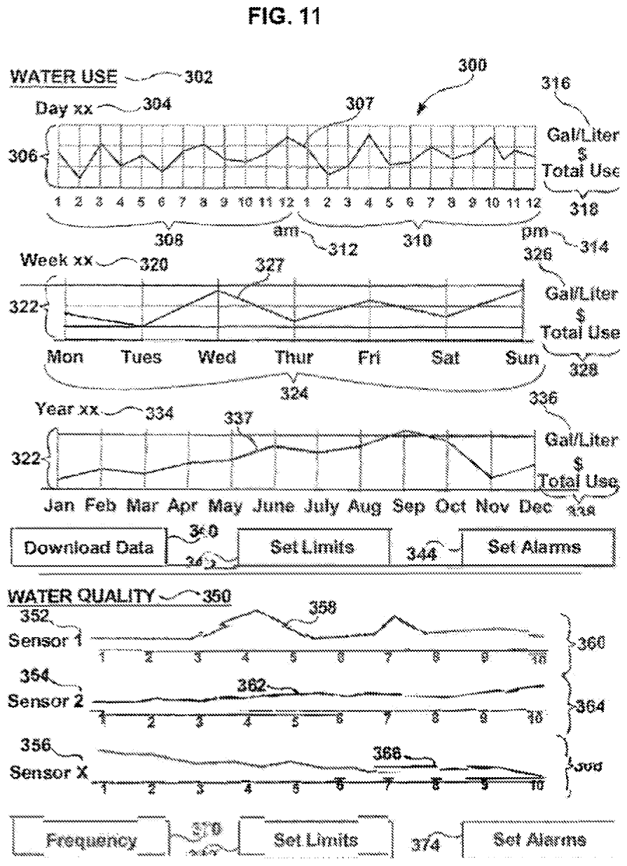

Now referring to more detail in FIGS. 10, (with different programs applications of APPS as shown in FIGS. 11, 12, 13) where water parameter data can be display on a cell phone, smart phone, and similar apparatus 400 as defined herein.

The cell phone, smart phone, remote computer, web portal or similar electronic apparatus 400 or custom display, recording apparatus 50, 56 and 110 has the convenient function of providing an individual or entity to review water use and water parameter data on a real time basis for auditing or monitoring purposes. It is also anticipated by the Applicants that the optional display means 12, 14, and 16 (shown in FIG. 2) can be located remotely from the water meter and leak detection system 10, 126, 200 containing the CPU or microprocessor 84 with communication and control lines 83 (shown in FIG. 3) that communicate either wired or wirelessly. Hence, the communication and control lines 83 can be used to transfer water use parameters and leak detection alerts to a remotely positioned display receiver apparatus (not shown) or the display means 12, 14, and 16 can be eliminated to be replaced by the first display and/or recording apparatus 50, 56, 110 or on a cell phone, smart phone, or similar apparatus 400. The wireless communication means 46, 52 and 56, can use radio-frequency, Bluetooth, Bluetooth low energy (BLE), ZigBee, Wi-Fi, Wi-Fi version 3/4/5/6, WiFi7, Li-Fi, LoRa, Sigfox, Ultra Narrow Band, 6LowPAN, NB-IoT, M-Bus, WIMAX, Amazon Sidewalk, standard cellular technology, LTE-M cellular technology, 3GPP, 4G and 5G cellular technology or other wireless technology for transferring the water parameter data generated by the sensors and collected by the microprocessor and sent to a wireless to a display means and/or a remotely positioned receiver apparatus or send control signals back to the water meter and leak detection system 10, 126, (and 200 in FIG. 7) with water shut-off/on mechanism 310. Examples of wireless protocols that can be utilized with the present invention include, but are not limited to, the IEEE 802.11a, IEEE 802.11b, IEEE 802.11g and IEEE 802.11n modulation techniques and the newer protocol associated with Wi-Fi3. Another example of the wireless protocols that can be utilized with the present invention is the ZigBee, Z-wave, M-Bus and IEE 802.15.4 modulation technology. Furthermore, wireless low power and long-range technology such as “LoRa” or Ultra Narrow Band chips (Ultra High-Performance RF Narrowband Transceiver) can be used with the present invention. Applicants recognize that there are numerous wireless protocols, such as Amazon Sidewalk, that have been recently developed that could be utilized with the present invention for data transfer purposes.

The water meter and leak detection system 10, 126, (and 200 in FIG. 7) with water shut-off/on mechanism 310, that transmits water parameter data to a router that connects to the internet and then to remote computers/servers, can also communicate the water leak condition with a user or owner of a home, condo, apartment or other residence, rental/leased house, condo or apartment or other resident, owner or representative of a company or corporate entity, owner or staff of a hotel/motel, institution facility, and/or a governmental agency, housing or facility using a cellular format technology that refers to all current and future variants, revisions and generations (e.g. third generation (3G), fourth generation (4G), fifth generation (5G) and all future generations) of Global System for Mobile Communication (GSM), General Packet Radio Service (GPSR), Code Division Multiple Access (CDMA), Evolution-Data Optimized (EV-DO), Enhanced Data Rates for GSM Evolution (EDGE), 3GSM, Digital Enhanced Cordless Telecommunications (DECT), Digital AMPS (IS-136/TDMA, Integrated Digital Enhance Network (iDEN), HSPA+, WiMAX, LTE, Flash-OFDM, HIPERMAN, Wi-Fi, IBurst, UMTS, W-CDMA, HSPDA+HSUPA, UMTS-TDD and other formats for utilizing cell phone technology, telephony antenna distributions and/or any combinations thereof, and including the use of satellite, microwave technology, the internet, cell tower, telephony and/or public switched telephone network lines. The wireless communication of water leaking conditions can be between the water meter and leak detection system 10, 126, 200 with water shut-off/on mechanism 310 and a typical cell phone, smart phones, or similar apparatus includes all remote cellular phones using channel access methods defined above (with cellular equipment, public switched telephone network lines, satellite, tower and mesh technology), mobile phones, PDAs, tablets (e.g. refers to all current and future variants, revisions and generations of the Apple IPAD, Samsung Galaxy, HP, Acer, Microsoft, Nook, Google Nexus, Sony, Kindle and all future tablets manufactured by these and other manufactures), Apple IPOD Touch, or a television, watch, timepiece or fob watch and other similar apparatus with WIFI and wireless capability, and remote computers and controllers having internet or wireless connectivity. The display of the water leaking condition data can be in various pleasing format using digits, analog display, graphics, pictures, charts and/or other characters to exhibit the leaking condition to a user. Also, the transfer of data can use authentication, encryptions, integrity, and non-repudiation technology to ensure that data or information is communicated securely.

Referring to FIG. 12, which shows a perspective view of a typical cell phone, smart phones, or similar apparatus 400 having an application 410, commonly known as an “APP”, programmed to display soft buttons or use control activators on a cell phone, smart phone, or similar apparatus 400, designed to wirelessly communicate or send signals to and from the water meter and leak detection system 10, 126, (and 200 in FIG. 7) with water shut-off/on mechanism 310. It is also anticipated that the apparatus 400 could be an Apple IPAD, HP, Samsung, LG, or other manufacture's tablet and that the application 402 that would function as described below. Furthermore, apparatus 400 could be a remote computer or television that is connected to the internet or has wireless capability. Shown in FIG. 12A is an example of application 410 which will typically display soft buttons for controlling water on 404 and water off 406 by sending wireless instructions to the water meter with leak detection system 10, 126, (and 200 in FIG. 7). It is anticipated by the Applicant that other configuration of application displays for remotely communicating with the water meter and leak detection system 10, 126, (and 200 in FIG. 7). The application 410 can also have a soft schedule button 408 which sequentially adds displays for entering a predetermined schedule for turning on and off the water at the collection node of the water meter and leak detection system 10, 126, 200. The predetermined schedule can be sent to the water meter with leak detection system 10, 126, (and 200 in FIG. 7) for continuous sequencing operations on an hourly, daily, weekly, monthly, or yearly basis. The predetermined schedule can be programmed into a memory module at the water meter and leak detection system 10, 126, (and 200 in FIG. 7).

An option of the application 410 is shown as a decisional text message 413 inquiring if the individual would like the water turned off and sent to display 402 of the cell phone, smart phone, or similar apparatus 400. The cell phone, smart phone, or similar apparatus 400 would preferably have incorporated GPS technology that can determine the location of the cell phone, smart phone, or similar apparatus, and know or saved the home or water meter with leak detection system 10, 126, 200 locations. Triangulation techniques between cell towers can also be used if the cell phone, smart phone, or similar apparatus 400 does not have GPS capability. The application 402 could or will have a routine that can program the distance from the water meter and leak detection system 200 that an individual desire to be provided a notice of the decisional text message. If the water is not turned off when the individual leaves the private or public property, and the cell phone, smart phone or similar apparatus 400 has been programmed for a set distance from the water meter collection node or optional communication hub 477 e.g. ¼ mile, then the decisional text message 417, for example, “Should I turn off the water supply”, will be sent to the cell phone, smart phone or similar apparatus 400. The rational for the decisional text message is that, for the present invention to function as a water damage prevention system, substantial compliance with routine turning off the water when a private or public property in unoccupied is necessary. The decisional text message 417 provides the individual a soft button “yes” 412 to turn off the water at the collection node of the water meter and leak detection system 10, 126, 200 or “no” 414 and leave the collection node of the water meter and leak detection 10, 126, 200 with the water control valve on. Hard button activators 416a, 416b and 416c can also be used to communicate with the water meter and leak detection system 10, 126, 200 that transfers water parameter data to the internet and then to remote computers/servers for cell phones, smart phones, or a similar apparatus that a display screens or no touch screen capability. For example, hard button 416a can communication with the water meter and leak detection system 10, 126, 200 to turn the water system on, hard button 416b can communication with the water meter and leak detection system 10, 126, 200 to turn the water system off, and hard button 416c can communication with water meter and leak detection system 10, 126, 200 to open a schedule page.

Another optional decisional text message 410 can sent to the cell phone, smart phone, or similar apparatus 400 if one of the optional highly sensitive flow sensors and 123 detects a leaking condition. The text message could specify “Leak found in kitchen area, should I turn of the water supply”. The decisional text message 410 provides the individual a soft button “yes” 412 to turn off the water at the water meter and leak detection system 10, 126, 200 or “no” 414 and leave the water meter and leak detection system 10, 126, 200 with the water control valve on. Hard button activators 416a, 416b and 416c can also be used to communicate with the water meter with leak detection system 10, 126, 200 for cell phones, smart phones, or a similar apparatus that a limited display screens or no touch screen capability. This optional leak detection message could also be sent the insurance or municipality agency monitoring station by PSTN or wireless means to notify of the leakage condition. It is also anticipated by the Applicant that the leak detection message could also be transferred to the supplying municipality to inform them of the leak such that the municipality can act to repair the leak condition.

Shown below in this FIG. 10 is a perspective view of an “APP” or programmed application that provides water use data in various example formats that is transferred from the water meter collection node or optional communication hub 477 to a remote display/recording apparatus 18, 50, 56, or a remote computer or a cell phone, smart phone, or similar apparatus 400. The programmed application or APP shows an average time of water use data, average water use data, water cost data, energy calculations using the water heater type, the state located, cost of natural gas or oil per Therm, efficiency information, and the average ambient water temperature and the desired water temperature use for hot water devices (e.g., shower, faucets). On the bottom of FIG. 16 is the water energy calculation and water costs for the day, week, month, year, and 2-year dates. The Applicant contends that many different water energy calculations can be used with the present invention without deviated from its intended use. The water meter and leak detection system can communicate with a said typical cell phone, smart phones, or similar apparatus includes an application for a consumer/resident, corporate entity, or municipality that show the daily, weekly and/or monthly water use and/or daily, weekly, or monthly water costs.

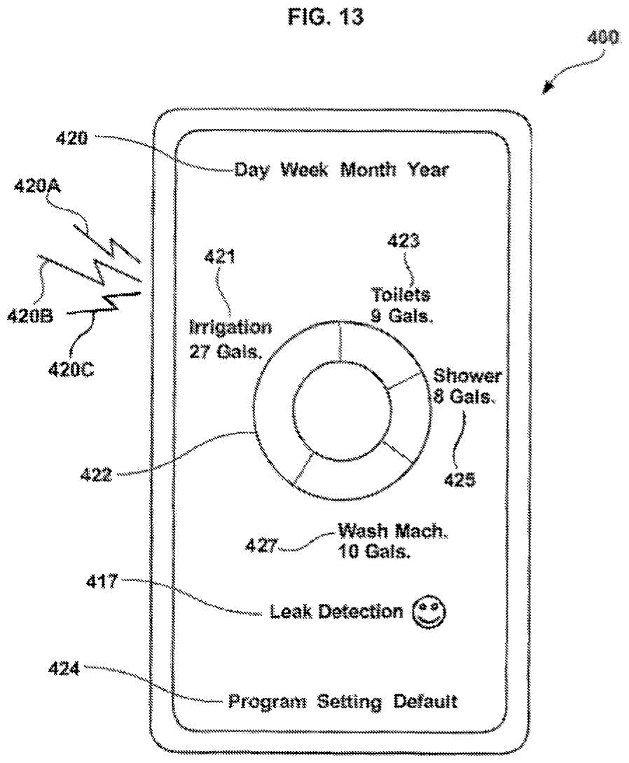

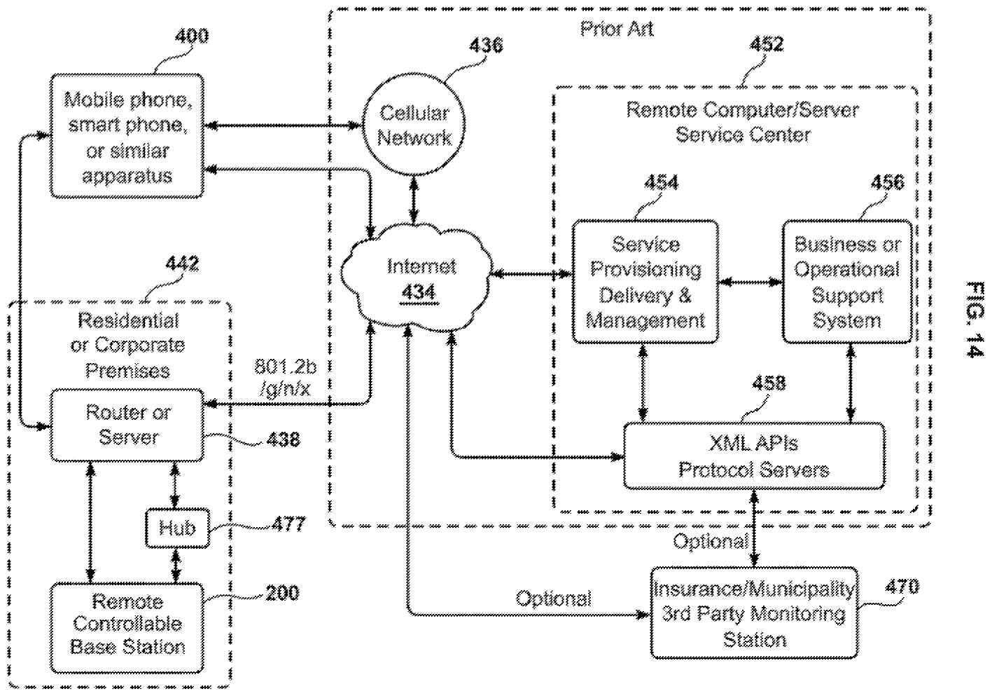

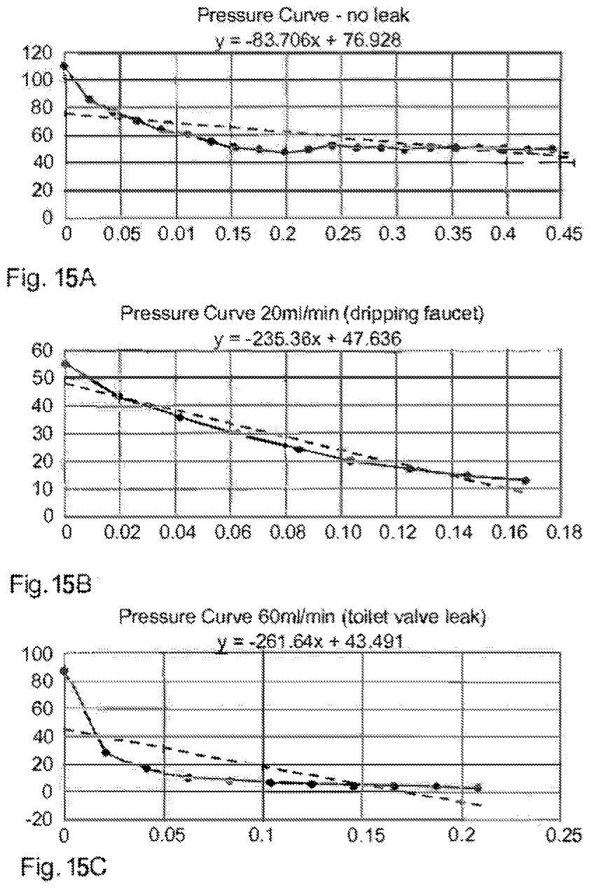

Shown in FIG. 11 is a perspective view of a first example application (APP), or a first page of an application (APP) 300, displayed on a typical cell phone, smart phone, or similar apparatus 400 (see FIGS. 12 and 13). This example application (APP) or page 300 is designed as a line graph format to be used by the resident of a home or a representative of a company or a corporation to monitor water conservation, but is it anticipated by the Applicant that the application (APP) 300 could be used by municipal or government representatives.

FIG. 11 shows and example of an application or page (APP) 300 for Water Use 302 having a daily 304 graph 306 with day hours 308, designated by the symbol AM 312 and the night hours 310 designated by the symbol PM 314. At the right side of the example application or page (APP) 300 is the daily total use of water 316 and the daily total cost in dollars (or other currency) 318 that has been downloaded the data 340 from the registered or serving water municipality. Within the daily graph 306 is a plotted line 307 that shows the hourly water use. The plotted line 307 can have a rolling feature whereby new data replaces the oldest data in the graph. A gallon or liter scale can be included on the left side of the daily graph 305 (not shown).

The example of an application or page (APP) 300 for Water Use 302 can also have a weekly 320 graph 322 with days 324. At the right side of the example first application or page (APP) 300 is the weekly total use of water 326 and the weekly total cost in dollars (or other currency) 328 that has been downloaded the data 340 from the registered or serving water municipality. Within the weekly graph 322 is a plotted line 327 that shows the daily water use. The plotted line 327 can have a rolling feature whereby new data replaces the oldest data in the graph. A gallon or liter scale can be included on the left side of the weekly graph 322 (not shown).

The example of an application or page (APP) 300 for Water Use 302 can also have a monthly 334 graph 330 with months 332. At the right side of the example first application or page (APP) 300 is the monthly total use of water 336 and the monthly total cost in dollars (or other currency) 338 that has been downloaded the data 340 from the registered or serving water municipality. Within the monthly graph 330 is a plotted line 337 that shows the daily water use. The plotted line 337 can have a rolling feature whereby new data replaces the oldest data in the graph. A gallon or liter scale can be included on the left side of the monthly graph 330 (not shown).

The water meter and leak detection system 10, 126, 200 is designed to transfer data and information by utilizing the wireless communication with the one or more remote display and/or recorder apparatus, or cell phone, smart phone or similar apparatus whereby the remote display and/or recorder apparatus or cell phone, smart phone or similar apparatus can automatically convert back and forth from radio frequency format, ZigBee or Bluetooth format to a cellular format technology to accommodate different range requirements.

FIG. 11 shows a download button 340 which is designed to manually or automatically download water rates and expense data from the servicing and registered water municipality or other source. The cost per gallon, hundred cubic feet (HCF) or other measurement is usually dependent on volume used over a given period. For example, from 0-8 HCF could be billed at $3.64 per HCF, 9-24 HCF could be billed at $4.08 per HCF, and 25-36 HCF could be billed at $5.82 per HCF. This is only an example data that can be downloaded and utilized to determine the daily cost 318, weekly cost 328, or monthly cost 338. Other data can be downloaded from the water municipality or other source such as warnings for drought conditions, metering policies, quality messages, limits, alarms, etc. The download button 340 can be used to download water use rates for different time of the day, or week.

FIG. 11 also depicts a user, whether it is a homeowner or company representative, who can Set Limits 342 for water use to command the water meter and leak detections system 10, 126, 200 to turn the water completely off for example, if a limit of water flow exceeds a limit, or sound a verbal or audio alarm. It is anticipated that the servicing and registered water municipality or other source can upload Set Limits 342 to the individual water meter and leak detections system 10, 126, 200. It addition, the Set Alarms 344 for water use can be used to display visually or provide audio signals of alarming conditions associated with the daily, weekly or monthly water use. The application (APP) 300 is designed to promote water conservation and monitor for leaking conditions.

FIG. 11 also shows an optional Water Quality section 350 of the application (APP) 300. As shown, optional water quality Sensor 1 (one) 352 can monitor one or more halogen elements or compounds, monitoring total dissolve solids, monitoring a metallic or iron element or compound, monitoring water hardness, monitoring biological or coliform contaminates, monitoring pH, or any combinations thereof. The plotted line 358 for Sensor 1 (one) shows peaks and valley over the time period 360. The time period can be selected for daily, weekly, or monthly. Sensor 2 (two) 354, can be another water quality sensor and Sensor X 356 can be one or more water quality sensor taken from the group define above.

For the optional Water Quality sensors 350, shown is a Frequency Soft Button which allows the user to define the time period, daily, weekly or monthly. A user, whether it is a homeowner or company representative, who can Set Limits 372 for water quality to command the water meter and leak detection system 10, 126, 200 to turn the water completely off, limit the flow, or sound a verbal or audio alarm. It is anticipated that the servicing and registered water municipality or other source can upload Set Limits 372 to the individual water meter and leak detection system 10, 126, 200 (with water shut-off/on mechanism 310). It addition, the Set Alarms 374 for water use can be used to display visually or provide audio signals of alarming conditions associated with the daily, weekly or monthly water use.

As FIG. 11 is only an example of presentation of the water use and water quality data, it is anticipated that other formats for displaying the daily, weekly, monthly, or annual water use and water quality use. Such formats can be in bar graph format, pie graph format, cosmography formats, tabular formats, time series graph formats, histogram formats, data plot format, scatter plot format, other graph formats, or a combination of these graph formats. In addition, it is anticipated that the water flow data presented in line graphs, tabular formats or graphic formats or any combination of the formats listed herein can be presented on one or more pages or screens of the typical cell phone, smart phone, or similar apparatus.

FIG. 12 shows one or more visual signals 409, 411 (e.g., LED or LCD) lights that are turned on (and off after a period of time) to communicate to an individual that the water meter and leak detection system 10, 126, 200 with water shut-off/on mechanism 310 has completed the programmed activity. For example, only, 409 could be a red LED light that illuminates when the water system is turned off and 411 could be a green LED light that illuminates when the water system is turned on. It is anticipated by the Applicant that verbal signal (verbal “water off” or verbal “water on” or simply a playing certain ringtones) can also be used to communicate that the programmed activity has been completed. Also shown near the middle of the “APP” (program) page is a soft button 404 for turning on the water system and anther soft button 408 for turning off the water system. A labeled 407 soft button 408 is used to bring up another page(s) that allows an individual to input a water on/off schedule. For example, one can have the water system or supply turned off automatically Monday-Friday from 8:00 a.m. until 5:00 p.m. when all the residences have been vacated (e.g. during work or school hours). For business and companies, the scheduling soft button 408 can turn off the water system or supply automatically when the employees of the business or company are vacated (e.g., from 6:00 p.m. until 7:00 a.m. Monday-Friday and all-day Saturday-Sunday. Various hard buttons 416A, 416B, and 416C can be used to supplement the soft buttons and/or menu pages for movement within the page or inputting data. On the bottom of the “APP” (program) is a text message sent to the homeowner or resident or business or company employee the option to turn on or off the water system or supply if the Water meter and leak detection system is aware that the home, building, or company is vacated (e.g., by temporal measurements, passive infrared sensors, entry and/or exit (badge) identification information. Shown on the side are the Bluetooth 420A, Wi-Fi, Wi-Fi versions 3/4/5/6 420B and cellular communication 420C means that wirelessly connects the cell phone, smart phone, or similar apparatus 400 to the water meter and leak detections system 10, 126, (and 200 in FIG. 7).

Typical cell phones, smart phones, and similar apparatuses 400 may have one or more means of communication that can be established with a particular water meter and leak detections system 10, 126, (and 200 in FIG. 7) for wireless communication. The use of Bluetooth wireless technology 420a is commonly a feature found on many cell phones, smart phones, and similar apparatus, Such Bluetooth wireless communication 420a can be a means to communicate with the water meter and leak detection system 10, 126, 200 with water shut-off/on mechanism 310 to turn the water on or off or receive decisional text messages 410. Zigbee is another wireless technology that can be used. However, most current cell phones, smart phones, or similar apparatus 400 do not possess Zigbee wireless capability.

The use of Wi-Fi (IEEE 802.11 family of wireless local area network) wireless technology 420b is commonly a feature found on many cell phones, smart phones, and similar apparatus 400 and wireless routers/servers. Such Wi-Fi wireless communication 420b can be a means to communicate remotely from a router/server directly to, or by the communication hub 477 circuitry to the collection node circuitry of the water meter and leak detections system 10, 126, (and 200 in FIG. 7) with water shut-off/on mechanism 310 to turn the water on or off or receive text messages. The water meter and leak detection system 10, 126, 200 can have the capability to receive and transfer wireless signals and decisional text messages 410 using Wi-Fi technology directly to the water meter and leak detection system 10, 126, 200 with water shut-off/on mechanism 310. Alternately, the Wi-Fi communication 420b will communicate with a wireless router/server that has a HTML or other communication-based interface and configuration page graphic user interfaces. Remote access from the cell phone, smart phone, or similar apparatus 400 could use a short message service (SMS) interface and/or voice of Internet Protocol (VOIP) which communicates with the wireless router. This Wi-Fi technology will access the internet through the wireless router and can recognize the cell phone, smart phone, or similar apparatus 400 phone number for remote capability using SMS interface. A digit numbers security can be used to maintain restricted integrity. Wireless Transmitters and Receivers can be used for Bluetooth, Bluetooth low energy, Wi-Fi, Wi-Fi versions 3/4/5/6, Wi-Fi7, and Li-Fi communication 420b to the water meter and leak detection system 10, 126, (and 200 in FIG. 7) for individuals lacking internet capability at their residence.

The use of cellular wireless technology 420c is a primary feature of cells phones, smart phones, and similar apparatus. Such cellular wireless communication 420c can be a means to communicate with the water meter and leak detection system 10, 126, 200 with water shut-off/on mechanism 310 to turn the water on or off or to receive text messages.

The application 410 can have to interface with the Bluetooth and Bluetooth Low Energy (BLE) 420a, WI-FI 420b, or cellular 420c wireless communication means, and send instructions to a water meter and leak detection system 10, 126, 200 and/or the Communication hub 477 for a pairing operation that allows for access to 1} observe the recorded data or 2) prevent an unauthorized individual to regulate the water control valve. Various pairing methods between the water meter and leak detection system 10, 126, (and 200 in FIG. 7) with water shut-off/on mechanism 310 and the cell phone, smart phone, or similar apparatus 400 are contemplated to be necessary to ensure that proper communication is established between a single and unique water meter and leak detection system 10, 126, 200 in addition to one or more unique cell phone, smart phone or similar apparatus 400. A Quick Response Code (QR code) unit address located on water meter and leak detection system 10, 126, (and 200 in FIG. 7) can communicate with a cell phone, smart phone, or similar apparatus 400 having a camera to read QR and establish link to the water meter and leak detection system 200. Standard barcodes could pair and establish a link between the water meter and leak detection system 10, 126, 200 with water shut-off/on mechanism 310 using the cell phone, smart phone, or similar apparatus 400. Near field link and RFID chip technology can also be used to facilitate pairing and establish a link between the water meter and leak detections system 10, 126, (and 200 in FIG. 7) and the cell phone, smart phone, or similar apparatus 400. Currently bar code readers are applications that can be downloaded for a particular cell phone, smart phone, or similar apparatus operation system. Near field links are becoming available on Samsung and Apple smart phones, but this technology may be expanded to many, if not all, cell phones, smart phones, or similar apparatus.

In operation, an individual who wants to turn off the water system would touch the off the soft button 408 or reply to the text message to turn off the water system “yes” soft button 412, or push the hard button 416b on the a cell phone, smart phone or similar apparatus 400 which will communication with the water meter and leak detection system 10, 126, (and 200 in FIG. 7) via the internet, wireless technology (e.g. Bluetooth, ZigBee, WiFi3/4/5/6, LoRa), and/or cellular format technology and then the paired water meter and leak detection system 10, 126, (and 200 in FIG. 7) with water control valve mechanism or shut-off/on mechanism 310 would turn off the water system off and then when completed (specified by switches and/or a flow sensor) will send a returned communication signal to the a cell phone, smart phone or similar apparatus 400 and turn on signal (audio or visual) message 409 that the water system is off. Comparable, an individual who wants to turn on the water system would touch the “on” the soft button 404 or reply to the text message to turn off the water system 410 “no” soft button 412, or push the hard button 416a on the a cell phone, smart phone or similar apparatus 400 which will communication with water meter and leak detections system 10, 126, 200 with water shut-off/on mechanism 310 via the internet, wireless technology (e.g. Bluetooth, ZigBee, Wi-Fi3/4/5/6, LoRa), and/or cellular format technology and then the paired water meter and leak detection system 200 would turn off the water system off and then when completed (specified by switches and/or a flow sensor) will send a returned communication signal to the a cell phone, smart phone or similar apparatus 400 and turn on signal (audio or visual) message 409 that the water system is off.

FIG. 13 is a perspective view of the embodiment comprising a home with the water meter and leak detection system 10, 126, 200 (with or without the water shut-off/on mechanism 310) interposed within the main water supply system 208 and the first distribution line for the home or company 310 and communicating wirelessly with a cell phone, smart phone, or similar apparatus 400 held in the hand 221 of an individual 212. The cell phone, smart phone, or similar apparatus 400 communicates with the water meter and leak detections system 10, 126, 200 using Bluetooth or ZigBee wireless technology 420a, Wi-Fi wireless communication 420b, Wi-Fi3/4/5/6, LoRa and/or cellular wireless technology 420c.

FIG. 14 is a block diagram of the overall system showing the software, hardware and software applications of the private or public property communicating with the water meter and leak detection system 10, 126, (and 200 in FIG. 7) and communicating with the internet and remote computer service station (“the Cloud”). The water meter and leak detection system 10, 126, (and 200 in FIG. 7) with water shut-off/on mechanism 310 includes, a preferred, but optional receiving station or communication hub 477 that connects either hard wired or wireless to a router/server 438 which connects in a duplex communication 440, 441 to the internet 434. The internet has duplex communication 461, 462 with the Remote Computer/Server Service Center 452 (e.g., Amazon®, Microsoft®, Oracle® and Google®). Within the Remote Computer/Server Service Center communicating with a cell or mobile phone, smart phone, or similar apparatus 400, smart internet TVs, smart central hub listening and speaker devices, and home control systems (408). At a user's private or public property, the water meter and leak detection system 10, 126, (and 200 in FIG. 7) (with water shut-off/on mechanism 310) connects to the router/server 438 with authentication, and preferable encrypted data. The water meter and leak detection system 10, 126, (and 200 in FIG. 7) with water shut-off/on mechanism 310 system communicates with the remote computers 452 located in the service provider's data center or hosted in integrated security system data center), with the communication taking place via a communication network (e.g., cellular network, internet, etc.).

The cell or mobile phone, smart phone, or similar apparatus 400, computer, cell phone, smart phone and similar apparatus, smart internet TVs, smart central hub listening and speaker devices, and home control systems, is used to wirelessly communicate with the water meter and leak detection system 10, 126, 200 (with water shut-off/on mechanism 310) via router/internet/remote servers. The cell or mobile phone, smart phone, or similar apparatus 400, computer, cell phone, smart phone and similar apparatus, smart internet TVs, smart central hub listening and speaker devices, and home control systems, preferably have downloaded programs or applications (“APPs”) that communicated with the water meter and leak detection system 10, 126, 200 (with water shut-off/on mechanism 310) for displaying water use, energy use and water quality as described herein. The cell or mobile phone, smart phone, or similar apparatus 400, computer, cell phone, smart phone and similar apparatus, smart internet TVs, smart central hub listening and speaker devices, and home control systems, that downloaded program or applications (“APPs”) can specifically turning on and off the water supply to a private or public property (ies) when it is not occupied either directly using a soft button of the APP or program a schedule using the APP. The water meter and leak detection system 10, 126, (and 200 in FIG. 7) with water shut-off/on mechanism 310 is not only designed to monitor for water use, energy use, and water quality, but to monitor of leak detection conditions and provide text messages, alerts signals, or emails regarding water leak conditions. The water meter and leak detection system 10, 126, (and 200 in FIG. 7) with water shut-off/on mechanism 310 can be programmed by the user to automatically shut off the water supply when a leak condition is observed. For purposes of brevity, water use data, water energy data, water quality data and leak detection signals and alerts utilizing the communication means described below.

The following remote computer components manage the main elements of the remote computer service, but this only exemplary and is not so limited. Several of the component defined and described can be replaces by a newly design operation(s), combine operations, or eliminate some operation(s). Professional companies, such as Amazon Web Services, handle most if not all of, the OSS and BSS services, database access, connectivity and database maintenance (e.g., SQL databases like MySQL, MariaSQL, and Aurora, Redshift, and non-SQL databases like Dynamodb), server component access and maintenance and load balancing, all for a cost base on various factors. Data access by cell phones, mobile phones, and similar apparatus 400, and remote computers can access the commercial database using certain protocols.

There are large cloud service companies with several computer server farms around the world that supplant the independent comprehensive internet infrastructure and communication network. Companies like Amazon®, Microsoft®, Oracle® and Google® have all built a significant quantity of computing infrastructure. Their data centers are vastly bigger, and significantly more efficient, than those operated by or could be built by most other independent companies. The cloud service companies with their worldwide server farms allow for scalable and redundant data storage capabilities (Redundant Array of Independent Disks or RAID technology). The large cloud-computer companies can temporarily extend or customize the functionality for a client by transferring logic to it that it can execute. Examples of this may include compiled components such as Java applets and client-side scripts such as JavaScript. Complying with these constraints, and thus conforming to the REST architectural style (REST an acronym for REpresentational State Transfer), which will enable any kind of distributed hypermedia system to have desirable emergent properties, such as performance, scalability, simplicity, modifiability, visibility, portability, and reliability (RestAPI). These large companies are presently marketing and renting out their computing capacity to developers and companies around the world. The developer or company doesn't have to incur the capital expense associated with designing network connectivity system, employing various Information technology (IT) professionals, purchasing the necessary computers and servers, developing the custom and non-custom software, and conducting the significant maintenance procedures.

A programmer/developer or a company simply pays for the cloud service services. Using the cloud service services provide the developer and company access to fundamentally unlimited computing power marketed by the cloud computing companies without must incur the expenses for developing and maintaining a private or corporate computer infrastructure.

There are various services, divided into certain categories, that are provided by the cloud computing companies. Infrastructure as a Service, or “IaaS,” is the most basic layer of cloud computing. It provides customers with virtual servers and database storage and Internet of Things (IoT) sensor communication and access. Platform as a Service, or “PaaS,” which is the set of application tools and services that make it easier for developers and IT professionals to build applications without the capital expense of purchasing software for application development. Software as a Service, or SaaS, which refers to applications that run in the cloud like Microsoft's Office 365, Google's G Suite and Salesforce's products for sales and marketing.

The plan for a cloud service company is to make their services indispensable to both independent software developers and small, medium, and large companies. Customers might venture into cloud computing with a single software application (APP) but as their businesses grow, their cloud-computer needs increase and the cloud service companies are expecting that their cloud usage and revenue will increase. Amazon® has increased their presence in the cloud industry, by sacrificing short term profits to enhance the customer experience and maximize long-term gain. The more customers a cloud platform provider contracts with, the more servers and serving farms under their control can be developed. And the more servers the cloud service companies have, the better they can take advantage of economies of scale and offer customers lower prices for more robust features, including appeal to large enterprises. The efforts to market cloud service services supports that the near future of internet infrastructures and communication networks will increasing be controlled and maintained by the large cloud service companies.

Specific communication protocols are becoming important to interface between the cloud service companies and the company's local or cloud database for computer, cell phone, smart phone and similar apparatus, smart internet TVs, smart central hub listening and speaker devices, and home control systems, access to acquire requested data (e.g. SQL database requests) and perform instructional activities (turn on/off water). Of these protocols, the Representational state transfer or RestAPI (or REST API), SOAP API, Java API, DOM API, SAX API, StAX API, or XML API are appropriate.

Once a user sets up a service, an activation application 494 delivers a first display (GUI or graphical user interface) to the user on either a display means of the computer, cell phone, smart phone, mobile phone or similar apparatus 400, computer, cell phone, smart phone and similar apparatus, smart internet TVs, smart central hub listening and speaker devices, and home control systems, on the water meter and leak detection system 10, 126, (and 200 in FIG. 7) and/or on a display means on the remote devices 480. This pairing technology or other application secure means associates a new user with a purchased or installed remote device and the water meter and leak detection system 10, 126, (and 200 in FIG. 7).

A number of applications provided by the large cloud service companies ensure overall management of the computer infrastructure and network service. These pre-defined applications are configured to offer off-the-shelf programs and operating systems solutions management of the integrated cloud service system service, overall service monitoring, customer support, and reporting.

The water meter base station communicates with one or more communication hubs or repeater apparatuses, the one or more communication hubs and repeater apparatuses function to extend the wireless range or forms a private network or corporate network that utilizes an application programming interface (API) software to communicate with a remote computer operation center, a commercial cloud-service or web-based service, the private network or corporate network comprising at least one of a Wi-Fi versions 3/4/5/6, WiFi7, Li-Fi, LoRa and LoRa WAN, Sigfox, Ultra Narrow Band, 6LowPAN, NB-IoT, M-Bus, WIMAX, Amazon Sidewalk, LTE-M cellular technology, 4G cellular technology and 5G cellular technology.

The water meter base station with wireless communication technology, the communication hubs and repeater apparatuses, the remote computer operation center, commercial cloud-service, the API software and private and corporate network can be marketed or sold as independent components and services, or the network system can be packaged together as a water project for a municipality, utility, town, or city.

While this invention has been described as having a preferred design, the present invention can be further modified within the spirit and scope of this disclosure. The application is therefore intended to cover any variations, uses, or adaptations of the invention using its general principles. Further, this application is intended to cover such departures from the present disclosure that arise from known or customary practice and the art to which this invention pertains, and which fall within the limits of the appended claims.

1. A water meter and leak detection system comprising:
a base station interposed between a main water supply line for a building or structure and a water supply from a water source provider;
said base station further comprising;
a) electrical circuitry including at least one of a CPU, microprocessor and microcontroller;
b) said base station having at least one of a one or more flow rate sensors and a one or more water quality sensors connected to the main water supply designed to monitor at least one of a water flow use data, a water energy use data, a water quality data, and a leak detection information from said building or structure, the one or more flow rate sensors connected with said electrical circuitry;
c) a power source that is at least one of an AC powered, a DC powered, and a battery powered source, the power source is electrically connected to said electrical circuitry;
d) said battery powered source comprising one or more standard or rechargeable batteries, the rechargeable batteries charged with a turbine or other rotational mechanism that generates electrical energy;
e) at least one of the CPU, microprocessor, and microcontroller connected with the electrical circuitry and is further capable of transmitting the water flow data, the water quality use data, the water energy use data and the leak detection information using a one or more wireless communication technologies;
f) the one or more wireless communication technologies comprising at least one of a Wi-Fi, Wi-Fi version 3/4/5/6, WiFi7, Li-Fi, LoRa, Sigfox, Ultra Narrow Band, 6LowPAN, NB-IoT, M-Bus, WIMAX, Amazon Sidewalk, standard cellular and 3GPP technology, LTE-M cellular technology and 4G and 5G cellular technology;
g) wherein the LTE-M cellular technology, 4G cellular technology and the 5G cellular technology can utilize eSIM technology;
h) wherein said one or more wireless communication technologies utilizes authentication and encryption technologies to prevent unauthorized access, spoofing or eavesdropping of the water data and information or transmitting signals or commands;
wherein when at least one of the CPU, the microprocessor, and the microcontroller with one or more flow rate sensors detects the initiation of a water flow, the at least one of the CPU, the microprocessor and the microcontroller instructs the water flow rate sensor to increase the sampling rate at a sufficient frequency capable to monitor at least one or more of a water flow rate, one or more water use durations and one or more total volume of water uses until water flow stops defining a water flow event;
the one or more wireless communication technology uploads the water flow use data, the water quality use data, the water energy use data and leak detection information using a private or corporate network or utilizing a router or access point and through the internet and to a remote computer operation center, to a cloud service company or to a web-based company;
at least one of a smart cell phone, mobile phone, PDA, tablet, remote computer, web portal, smart or internet capable television, wireless smartwatch and other electronic communication apparatuses communicating with one or more wireless communication technology having a graphical user interface (GUI) to display at least one of the water use data, the water quality use data, the water energy use data and the leak detection information that is downloaded through a private or corporate network or utilizing a router or access point through the internet from a remote computer operation center or from a cloud service company;
wherein the communication between the base station and the remote computer operation center or the cloud service company can utilize an application programming interface (API).

2. The water meter and leak detection system as recited in claim 1, further comprising a water control valve mechanism; the water control valve mechanism comprising an on/off water control valve mechanism, a variable open design water control valve mechanism or a three-way water control valve mechanism.

3. The water meter and leak detection system as recited in claim 1, wherein said one or more wireless communication technologies interface with remote computers or servers utilizing an application programming interface consisting of at least one of a REST-API, SOAP-API, Java API, DOM API, SAX API, StAX API, and XML API protocols.

4. The water meter and leak detection system as recited in claim 1, further comprising at least one of an acoustic and a pressure sensor that monitors vibration frequencies noise patterns from water use device control valves and assist in at least one of identifying the particular water control valves fixtures or appliances and monitoring for water leaks, modify software instructions and provide information for artificial intelligence algorithms for detecting water patterns and signatures of fixtures and appliances and conditions.

5. The water meter and leak detection system as recited in claim 2, wherein the leak information can provide a registered owner and user a warning or signal to at least one of said smart phone, computer, server, web portal, and other electronic communication devices when a leak condition is observed, wherein said registered owners and users can be provided a number of corrective selections that comprise at least one of the ability to remotely turn off the main water system, contact an individual by phone call, text, or email for initiating corrective actions and previously programming the system to automatically turn off the water upon the detection of a leak condition and then sending a message that water has been turned off.

6. The water meter and leak detection system as recited in claim 2, further a temperature sensor in close proximity to said water supply, said temperature sensor can communicate with the water meter and leak detection system and can send a freezing warning message on at least one of the smart phone, remote computer, server, tablet, or web portal when the water temperature approaches freezing or can be programmed to initiate water freezing protection procedures when the water supply line approaches the water freezing point of 32 degrees Fahrenheit or 0 degrees Celsius, such freezing protection procedures can include at least one of incorporating a freeze plug mechanism, draining the distribution lines with the three-way water control valve mechanism, replacing the water in the water line with an air, nitrogen, of other gas or liquid having a low freezing point, the water meter and leak detection system.

7. The water meter and leak detection system as recited in claim 1, further comprising that at least one of the CPU, the microprocessor, or the microcontroller can include software that can include at least one of a device calibration mode and an automatic learning mode, wherein the device calibration mode utilizes activation of the water use devices, appliances and fixtures and monitors the water flow event at specific intervals, wherein the automatic learning mode utilizes a period of self-learning of the water flow events of water use devices, appliances and fixtures.

8. The water meter and leak detection system as recited in claim 1, is capable of including a second wireless technology comprising at least one of a Bluetooth, Bluetooth Low Energy, and Wi-Fi wireless technology that is capable of performing an authentication pairing procedure for initially establishing remote wireless communications by inputting a network username and a password, scan a QR code, or perform a two-step authentication scheme.

9. The water meter and leak detection system as recited in claim 1, further comprising the at least one of the CPU, the microprocessor can at least include one of a programming setting managed by a user to remotely establish a mode setting, or modify a default setting processed by a manufacturing factory to:
a) record the water flow event to a local memory module or a removable memory device for subsequent analysis,
b) combine a plurality of water flow events into a local memory module and subsequently schedule the transfer of the series of water flow events to a remote computer or server, or to a cloud service company,
c) directly and immediately transfer the water flow event to a remote computer or server, or to a cloud service company, or
d) transfer the water flow data utilizing a blockchain format to one or more remote computers or servers, or cloud service company.

10. A water meter and leak detection system comprising:
a collection node interposed between a main water supply line for a building or structure and a water supply from a water source provider;
said collection node further comprising;
a) an electrical circuitry including at least one of a CPU, a microprocessor, and a microcontroller;
b) said collection node having at least one of a one or more flow rate sensors and a one or more water quality sensors connected to the main water supply and designed to monitor at least one of a water flow use data, a water energy use data, a water quality data and leak detection information from said building or structure, the one or more flow rate sensors connected with said electrical circuitry;
c) a power source that is at least one of an AC powered, a DC powered, and a battery powered source, the power source is electrically connected to said electrical circuitry;
d) said battery powered source comprising one or more standard or rechargeable batteries, said rechargeable batteries the rechargeable batteries charged with a turbine or other rotational mechanism that generates electrical energy;
e) wherein the at least one of the CPU, the microprocessor, and the microcontrollers is further capable of transmitting the water flow use data, the water energy use data, the water quality data and leak detection information using one or more wireless communication technologies;
f) one or more wireless communication technologies comprising at least one of Wi-Fi, Wi-Fi version 3/4/5/6, WiFi7, Li-Fi., LoRa, Sigfox, Ultra Narrow Band, 6LowPAN, NB-IoT, M-Bus, WIMAX, Amazon Sidewalk, standard cellular, LTE-M and 5G cellular technology;
g) wherein the LTE-M cellular technology, 4G cellular technology, and 5G cellular technology can utilize eSIM technology;
h) wherein said one or more first wireless communication technologies utilizes authentication and encryption technologies to prevent unauthorized access, spoofing or eavesdropping of the water flow use data, the water energy use data, the water quality data and leak detection information and information or transmitting signals or commands;
wherein at least one of the CPU, the microprocessor, and the microcontroller transfers the water flow use data, the water energy use data, the water quality data and leak detection information by wired or wireless communication technology to a one or more remote communication hubs or one or more repeater apparatuses;
wherein the one or more communication hubs or the one or more repeater apparatuses having one or more wireless communication technology that corresponds to the one or more wireless communication technology of the collection node, wherein the one or more communication hubs function to extend the range of wireless communication technology or enable meshing technology;
the one or more communication hubs or the one or more repeater apparatuses having a second electrical circuitry including at least one of a second CPU, a second microprocessor, and a second microcontroller, and a second power source;
wherein the second electrical circuitry has programmed instructions for receiving and processing the water flow use data, the water energy use data, the water quality data and leak detection information transmitted by the one or more wireless communication technology of the collection node through a private or corporate network or utilizing a router or access point and through the internet and to a remote computer operation center or to a cloud service company;
at least one of a smart cell phone, mobile phone, PDA, tablet, remote computer, web portal, smart or internet capable television, wireless smartwatch and other electronic communication apparatuses communicating with one or more wireless communication technology having a graphical user interface (GUI) to display at least one of the water flow use, the water quality use, the water energy use and the leak detection information that was downloaded from a private or corporate network or utilizing a router or access point through the internet from a remote computer operation center or from a cloud service company;
wherein the communication between the base station, the one or more communication hubs or the one or more repeater apparatus, and the remote computer operation center or the cloud service company, can utilize an application programming interface;
the second CPU, microprocessor or microcontroller can at least include one of a programming setting managed by a user to remotely establish a mode setting, or modify a default setting processed by a manufacturing factory to:
a) record a water flow event to a local memory module or removable device for subsequent analysis,
b) combine a plurality of water flow events into a local memory module and subsequently schedule the transfer a series of water flow event to a remote computer or server, or to a cloud service company,
c) directly transfer the water flow event to a remote computer or server, or to a cloud service company, or
d) transfer the water flow data utilizing a blockchain format to one or more remote computers or servers, or cloud service company.

11. The water meter and leak detection system as recited in claim 10, further comprising a water control valve mechanism compromising an on/off water control valve mechanism, a variable open design water control valve mechanism, or three-way water control valve mechanism.

12. The water meter and leak detection system as recited in claim 10, wherein said one or more wireless communication technologies interface with remote computers or servers utilizing an application programming consisting of REST-API, SOAP-API, Java API, DOM API, SAX API, StAX API, and XML API protocols.

13. The water meter and leak detection system as recited in claim 10, further including at least one of a mesh and a peer-to-peer technology circuitry wherein the mesh and the peer-to-peer technology enables the one or more communication hubs or one or more repeater apparatuses to communicate with a one or more water meter collection nodes.

14. The water meter and leak detection system as recited in claim 10, transmitting at least one of a water flow use data, water energy use data, water quality data, and leak detection information initiated by a command signal from at least one of said smart phone, computer, server, tablet, web portal, and other electronic communication technology devices.

15. The water meter and leak detection system as recited in claim 10, wherein the collection node or communication hub can locally download the at least one of the water flow use, the water quality use, the water energy use and the leak detection information, or download the at least one of a water flow use, a water duration use, or a total water volume use to a remote computer or cloud service company such that at least one of an hourly, daily, weekly, monthly or annually series of at least one of the water flow use, the water quality use, the water energy use and the leak detection information or the water flow use, the water duration or the total water volume use is available for review by registered users or municipality agencies.

16. The water meter and leak detection system as recited in claim 10, wherein the leak information can provide the registered user a warning or signal on at least one of said smart phone, computer, server, web portal, and other electronic communication devices when a leak condition is observed, wherein said registered owners and users can be provided a number of corrective selections that comprise at least one of the ability to remotely turn off the main water system, contact an individual by phone call, text, or email for initiating corrective actions, or previously programming the system to automatically turn off the water upon the detection of a leak condition and then sending a message that water has been turned off.

17. The water meter and leak detection system as recited in claim 2, further comprising a temperature sensor in close proximity to said water supply, said temperature sensor can communicate with the water meter and leak detection system and can send a freezing warning message on at least one of the smart phone, remote computer, server, tablet, or web portal when the water temperature approaches freezing or can be programable to initiate water freezing protection procedures when the water supply line approaches the water freezing point of 32 degrees Fahrenheit or 0 degrees Celsius, such freezing protection procedures can include at least one of incorporating a freeze plug mechanism, draining the distribution lines with the three-way water control valve mechanism, replacing the water in the water line with an air, nitrogen, of other gas or liquid having a low freezing point, the water meter and leak detection system.

18. The water meter and leak detection system as recited in claim 10, further comprising at least one of a pressure sensor and an acoustic sensor wherein said at least one of the pressure sensor, the acoustic sensor and the flow rate sensor utilizes a calibrate mode or a learning mode to communicate a series of water flow events to at least one of a software instructions, a software algorithm and artificial intelligence for detecting water patterns and signatures of fixtures and appliances and leak conditions.

19. The water meter and leak detection system as recited in claim 10, is capable have a further comprising second wireless communication technology utilizing at least of one of a Bluetooth, Bluetooth low energy, Zigbee, Z-wave and Wi-Fi, Wi-Fi versions 3/4/5/6 wireless technology for performing an authentication pairing procedure to initially establishing remote wireless communications by inputting a network username and a password, scan a QR code or perform a two-step authentication scheme.

20. A water meter and leak detection system as recited in claim 10, further comprising an acoustic sensor that monitors vibration frequencies from the water control valve mechanism and identifying a one or more particular water control valves incorporated within a fixture or an appliance while monitoring for water leaks.
